(19) United States
(12) Patent Application Publication
(10) Pub. No.: US 2004/0050406 A1
(43) Pub. Date: Mar. 18, 2004

(54) Compositions and method for removing photoresist and/or resist residue at pressures ranging from ambient to supercritical

(76) Inventor: Akshey Sehgal, Eagle, ID (US)

Correspondence Address: STALLMAN & POLLOCK LLP, Suite 290, 121 Spear Street, San Francisco, CA, 94105, US

(21) Appl. No.: 10/620,895

(22) Filed: Jul. 16, 2003

Related U.S. Application Data
(63) Continuation-in-part of application No. 10/197,384, filed on Jul. 17, 2002.

(51) Int. Cl. B08B 3/00

(52) U.S. Cl. 134/26; 510/175; 510/176; 510/201

(57) ABSTRACT

A method of enhancing removal of photoresist and/or resist residue from a substrate includes exposing the substrate to an environmentally friendly, non-hazardous co-solvent mixture comprising a carbonate, an oxidizer and an accelerator. The stripping process may be performed under ambient conditions, or in the presence of a supercritical fluid such as supercritical carbon dioxide with the supercritical cleaning step itself being a desirable “green” process. In one embodiment, the co-solvent mixture includes propylene carbonate, benzyl alcohol, hydrogen peroxide and an accelerator such as formic acid. If desired, supercritical carbon dioxide in combination with a second co-solvent mixture may be subsequently applied to the substrate to rinse and dry the substrate. In one embodiment, the second co-solvent mixture includes a lower alkyl alcohol such as isopropyl alcohol.

### PRIORITY

This application is a continuation-in-part of U.S. application Ser. No. 10/197,384, filed Jul. 17, 2002, which is incorporated herein by reference.

### FIELD OF THE INVENTION

The present invention relates to compositions and methods for removing photoresist and/or resist residue from a semiconductor substrate at pressures ranging from ambient to supercritical.

### BACKGROUND OF THE DISCLOSURE

The semiconductor industry continues to make chips that are faster in performance and cheaper in cost. This has been achieved by making the devices smaller, more complex and by creating multi-level metallization structures. To keep these miniaturized circuits operational, stringent cleanliness requirements are vital. Contamination that may not have affected the electrical performance and reliability of devices with large geometries may become a “killer” defect for devices with sub-micron critical dimensions. It is thus highly desirable to minimize the amount of contamination present on the substrate surface at the end of each step in the integrated circuit fabrication process.

The second most repeated step in fabricating semiconductor integrated circuits is the application of organic photoresist material to a semiconductor substrate as a precursor to formation of features on the substrate using photolithography techniques. Often additional coatings, for example an anti-reflective coating known in the industry as BARC (Back Antireflective Coating), are applied to the substrate to enhance the lithography process.

Once lithography is completed, the resist, BARC and other coatings used for the lithography steps must be removed from the substrate. Undesired resist and/or resist residue can have deleterious effects on subsequent processes such as metallization, or cause undesirable surface states and charges. A common technique for photoresist removal involves placing the substrate in an asher and burning the resist and associated coatings using a gaseous plasma. While the high temperature in the plasma process chamber oxidizes the photoresist and removes it, the plasma etch process leaves post-ash residues—undesirable byproducts from the reaction of the plasma gases, reactant species and the photoresist. These by-products are generally referred to as “sidewall polymer,” “via veil,” “goat horns,” etc. and cannot be completely removed by the etch process. Thus, the substrate must be subsequently placed in a wet cleaning tool to remove byproducts of the plasma etch process, and then rinsed and dried.

Moreover, the plasma etch procedure for resist removal is less desirable for substrates having low dielectric constant (or “low-k”) films as insulating layers. These insulating layers, such as SiO₂ with carbon, are porous and are thus more likely to absorb etch gases which can later out-gas and attack metal contacts formed into the substrate (e.g., dual damascene copper).

Another currently used photoresist removal process includes exposing the substrate to a liquid photoresist stripper containing at least one polar solvent. At times, however, the byproducts of the stripping process and the stripping solution itself may be left behind in fine features formed in the substrate. Therefore, additional steps of rinsing out the stripper and stripper residues and drying the wafer must follow the wet stripping process.

Despite a long history of wet stripping photoresists and resist residues, the semiconductor industry is faced with a challenging problem in removing photoresist and/or resist residues. Due to ever-present pressure to miniaturize and thereby increase device density on the chip, newer type of photoresists (chemically amplified) are required and used in photolithography. These resists have proved to be more difficult to remove than the resists they replaced. Also to produce higher and higher aspect ratio vias (vias are long channels that connect the various conductive layers in a multi-level stack), the plasma and reactive ion etching procedures have become more aggressive and longer in duration. The result is that the high vacuum and temperature conditions of the etcher produce extensively cross-linked photoresist and/or resist residue, which are not satisfactorily removed by commercial strippers. In addition, the formulations of these strippers contain toxic solvents and solvent combinations. While these solvents and solvent combinations were once accepted as useful, they have come under increasing public scrutiny and governmental regulation for the health and environmental risks they pose. Accordingly, researchers have desired to discover new solvent and solvent combinations that exert the same or greater solvency characteristics for a variety of resist and resist residue with at least the same degree of convenience exhibited by the previously employed solvents. These strippers need to exhibit little or no human or environmental toxicity, be biodegradable and non-flammable and evidence little or no tendency to evaporate.

While the need for new, environmentally friendly solvents is clear, a desirable replacement solvent is one that performs at a lower cost and faster processing speed. As cleaning is the most repeated step in semiconductor integrated circuit manufacturing, any method that speeds up cleaning will have a large positive impact. As described earlier, current industry techniques require at least two processing steps for photoresist and resist residue removal; and separate steps may be needed to rinse and dry the wafer. It is highly desirable to expedite and thereby reduce the cost of the resist removal process by eliminating the need for follow-on cleaning and/or drying steps. It would be desirable to carry out the resist and/or resist residue removal and drying of the wafer in one step at low temperature.

Removing resist and/or resist residue, and drying of the wafer in one step at low temperature is possible using the compositions and methods disclosed herein for supercritical processing. Supercritical conditions are created by a combination of pressure and temperature of the environment above which a substance enters its supercritical phase. In a supercritical state, the substance has properties both of a liquid and a gas, i.e., the liquid and gaseous states of matter exist together as a single phase. FIG. 1 shows the conditions needed to achieve supercritical conditions for carbon dioxide. Carbon dioxide has a critical temperature of 31° C. and a critical pressure of 72.8 atm. Thus, when CO₂ is subjected to temperature and pressure above these critical conditions, it is in the supercritical state. A substance that is in the supercritical state is known in the art as a “supercritical fluid.”

Supercritical fluids are desirable in the context of integrated circuit fabrication for a variety of reasons. For example, supercritical fluids have very low surface tension, which enables them to achieve better effective contact with surfaces and better penetration into high aspect vias and boundary layer films than substances in the liquid state. The low viscosity of supercritical fluids allows for relative fast mass transfer.

The industry trend is towards shrinking semiconductor device structure geometries and other structure geometries into the submicron range such as below 0.13 micron. Nevertheless, the industry lacks a first-rate method of removing photoresist and/or resist residue from high aspect ratio openings such as submicron grooves, narrow crevices etc. without damaging the structure being produced. Supercritical fluids are suitable for this purpose because they can readily penetrate these high aspect ratio openings and effectively remove resist and/or resist residues from them. In addition, the supercritical fluid and/or co-solvent composition can be exactly tailored to selectively attack only the resist and/or residue without attacking the semiconductor device structures. Moreover, it has been found that using supercritical fluids for resist/residue removal can eliminate process steps thereby increasing wafer throughput at a lower cost.

Using methods and compositions described herein, a single step using supercritical fluids may be used to remove resist and/or resist residue and to dry the substrates, providing a distinct advantage over prior art methods requiring follow-on cleaning and/or drying steps. This not only accelerates the wafer processing but also results in a decreased consumption of solvents and/or water used in cleaning, rinsing and drying. Corrosion of the IC structure/stack is also reduced because of the small amounts of co-solvent used in a controlled manner, as compared to the wafer being immersed in a large bath for an extended period of time and then subjected to further rinsing to remove the solvent. These environmental benefits make supercritical cleaning of semiconductor wafer substrates using the described methods a desirable “green” process.

Supercritical CO₂ (“scCO₂”) is a supercritical substance suitable for integrated circuit fabrication because its critical pressure and temperature are relatively easy to achieve, and therefore, does not have high equipment and operating costs. It is non-toxic and non-flammable, it is inert to inorganic materials found on wafers, and it is not an ozone layer depleting chemical. High purity grades of CO₂ can be readily obtained and are inexpensive.

Prior attempts to use scCO2 in photoresist removal processes have achieved limited success. The resulting processes have been commercially undesirable for various reasons. For example, the existing processes require unduly long processing times for complete photoresist and residue removal, and/or use excessive amounts of process fluids, and/or require unacceptable quantities of toxic substances, and/or negatively impact device performance, and/or fail to completely remove photoresist and resist residues. It is therefore desirable to provide a process for removing photoresist and/or resist residue that is fast, efficient, and environmentally friendly.

As set forth in detail below, the present inventor has developed compositions and methods that overcome the problems detailed above and which allow for successful removal of photoresist and/or resist residue using scCO₂. It has been found, inter alia, that these co-solvent compositions are quite effective at removing photoresists at ambient pressures as well.

### SUMMARY OF THE DISCLOSURE

A method of removing photoresist and/or resist residue from a substrate includes exposing the substrate to a co-solvent mixture comprising one or more organic solvents, an oxidizer and an accelerator. The exposure can occur at ambient pressure or in a process chamber filled with a supercritical fluid. If desired, supercritical carbon dioxide in combination with a second co-solvent mixture may be subsequently applied to the substrate to rinse and dry the substrate. In one embodiment, the second co-solvent mixture includes lower alkyl alcohols such as Methanol, Ethanol or Isopropyl Alcohol.

### BRIEF DESCRIPTION OF THE DRAWINGS

FIG. 1 is a phase diagram illustrating the supercritical phase of carbon dioxide.

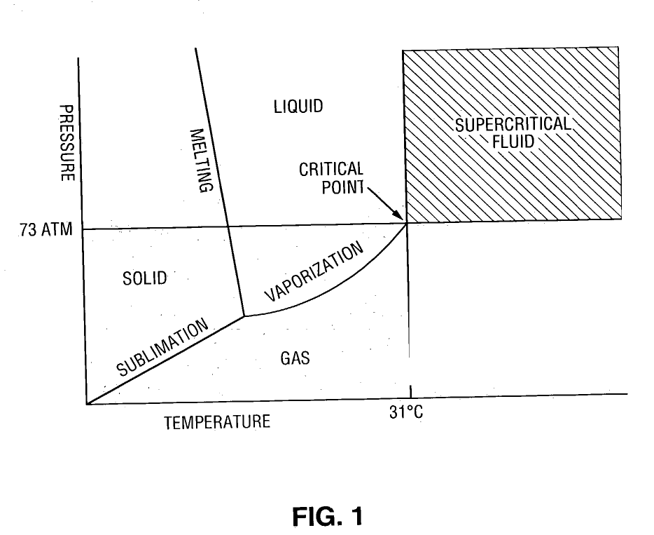

FIG. 2 is a simplified schematic representation of a pressure chamber of a type which may be used in connection with the composition and method described herein.

### DETAILED DESCRIPTION

Disclosed herein are compositions and methods for removing photoresist, and/or residues remaining after photoresist removal, from substrates at ambient pressures or under supercritical conditions using supercritical fluids. The disclosed methods and compositions offer improvements in removal of photoresist and/or resist residue from a substrate, and they preferably do so using an environmentally friendly, non-hazardous co-solvent mixture. It is readily apparent to one skilled in the art that while the disclosed methods are described in terms of removing photoresist and/or the resist residue, these methods are equally applicable to removing the photoresist and the residue, or removing the photoresist only, or to removing the residue only. For simplicity, the term “stripping” may also be used to describe photoresist removal, and “cleaning” may be used to describe removal of resist residue.

In the semiconductor industry, the terms “wafer” and “substrate” are to be understood as including any semiconductor based structure, which may have an exposed layer which may be effectively cleaned by the process(es) disclosed herein. Typically this will include semiconductor based structure which have been etched and have resultant photoresist and/or resist residue (inorganic, organometallic and/or organosilicate) on an exposed layer. However other structures may also be beneficially treated by the present method. The terms “wafer” and “substrate” may include silicon-on-insulator (SOI) or silicon-on-sapphire (SOS) technology, doped and undoped semiconductors, epitaxial layers of silicon supported by a base semiconductor foundation, and other semiconductor structures. In addition, the semiconductor need not be silicon based but could be based on silicon-germanium, germanium, or gallium arsenide.

Embodiments Using Supercritical Fluids

In one embodiment, a composition for removing photoresist and/or resist residue includes a supercritical fluid such as supercritical CO₂ in combination with one or more co-solvents and a method includes exposing one or more substrates to the supercritical CO₂ and co-solvent(s). The supercritical fluid carries the co-solvent(s) into contact with the substrate and into high aspect vias, allowing the co-solvent(s) to strip the photoresist/residue. If desired, a second co-solvent may be introduced into contact with the substrate to remove the first co-solvent and any by-products and rinse and dry the substrate. The rinsing and drying step may be performed in a supercritical chamber where a supercritical fluid carries the second co-solvent into contact with the substrate and its high-aspect vias.

The compositions and methods described herein may be used without pressure cycling the system during the photoresist/residue removal process. They may also be used with non-toxic co-solvent mixtures. Photoresist and/or photoresist residue may be removed from various types of substrates, include substrates having features that are etched into a low dielectric constant material.

A preferred supercritical fluid used in the composition/method is supercritical CO₂, although it should be appreciated that other components in supercritical form may be used alone or in combination with each other or with supercritical CO₂. Such components may include, but are not limited to supercritical forms of the following: Ar, He, CH₄, C₂H₆, n-C₃H₈, C₂H₄, CHF₃, N₂, N₂O, and the like. Throughout this discussion, the term “supercritical component” may be used to describe the supercritical substance before it has been brought to its supercritical state.

Supercritical CO₂ is preferred because it is easily and cheaply available in high purity grades and because its supercritical conditions are achieved at moderate temperatures and pressures. In addition, the zero dipole moment of CO₂ ensures that it is a poor solvent for polar substances until substantially higher operating pressures (more than 4 times its critical pressure) are used. At those high pressures, the solvating ability of the scCO₂ alone is so high that it would begin dissolving parts of the semiconductor device structure along with the resist and/or resist residue and loses its selective cleaning ability.

In the disclosed methods and compositions for resist stripping and/or resist residue removal cleaning is accomplished using a co-solvent mixture. This co-solvent mixture can be tailored to selectively attack only the resist and/or resist residue without damaging the sub-micron semiconductor device structures. The role of scCO₂ is to act as a pressurizing medium so that the surface tension of the co-solvent mixture is decreased such that it can easily penetrate (and be removed from) the high aspect vias in sub-micron semiconductor device structures. This leads to complete wetting of all surfaces to accomplish complete, uniform cleaning. The pressure of the scCO₂ system increases the reaction kinetics of the co-solvent mixture attack, thereby accomplishing cleaning in a shorter time.

For the purposes of this description, the mixture used for photoresist stripping will be referred to as the “co-solvent 1” mixture, while the solvent or mixture of solvents used to rinse and dry the wafer (if desired) will be referred to as “co-solvent 2”. The co-solvent 1 mixture preferably includes one or more organic solvent(s) for stripping the photoresist, and an oxidizer for attacking the photoresist and dissolving the cross-linked bonds in the photoresist. The oxidizer causes the co-solvent mixture to dissolve the photoresist and/or resist residue layer by layer rather than by undercutting it (as would occur with the co-solvent(s) alone). The supercritical fluid carries the co-solvent mixture into contact with the substrate and into high aspect vias, allowing the polar co-solvent(s) to strip the photoresist and allowing the oxidizer (if used) to attack the cross-linked bonds of the photoresist. The co-solvent(s) and oxidizers may be added to the supercritical component either before it is brought to its supercritical state, or after it has been brought to its supercritical state. The co-solvent 1 mixture may alternatively be provided without any oxidizer. The organic solvent may be polar or non-polar, may be protic or aprotic, may be cyclic, branched or straight chained, and may contain one or more functional groups. The organic solvent(s) could be from a wide variety of representative classes such as:

Alcohols (Benzyl Alcohol, Diacetone Alcohol, Furfuyrl Alcohol, Hexylene Glycol, Methylbenzyl Alcohol (all four of its isomers: alpha, ortho, meta and para), Phenoxy Ethanol, Phenoxy Propanol, Propargyl Alcohol, Tetrahydrofurfuryl Alcohol and the like and mixtures thereof),

Amides (Acetamide, Dimethyl Acetamide, Dimethyl Formamide, Formamide, and the like and mixtures thereof)

Amines (Diethanolamine, Diglycolamine, Ethylene Diamine, Isopropyl Amine, Monoethanolamine, Triethanolamine, and the like and mixtures thereof)

Carbonates (Including alkylene carbonates such as Ethylene, Propylene or 1,2-Butylene Carbonate and mixtures thereof. Dialkyl carbonates of the formula R—CO₃—R′ where R and R′ may or may not be the same group can also be used. Examples of dialkyl carbonates are dimethyl carbonate and diethyl carbonate. The dialkyl carbonates may be used singly or as mixtures of dimethyl- and diethyl-carbonates. Mixtures of alkylene and dialkyl carbonates may be also be used).

Chlorinated Hydrocarbons (Perchloroethylene, Trichloroethylene, 1,1,1 Trichloroethane and the like and mixtures thereof)

Ester solvents (N-Amyl Acetate, Dibasic Ester Mix or DBE available commercially from DuPont, Ethyl Lactate, γ-Butyrolactone and the like and mixtures thereof)

Ethers (Anisole, Benzyl Ether, 1,3-Dioxolane, 1,4-Dioxane, Furan, Tetrahydrofuran, 1,3,5 Trioxane and the like and mixtures thereof)

Glycols (Ethylene, Propylene and Butylene Glycols, Methyl Propanediol, Triethylene Glycol and the like and mixtures thereof)

Glycol Ethers (Diethylene Glycol Butyl Ether, Dipropylene Glycol Methyl Ether, Propylene Glycol Methyl Ether, Propylene Glycol n-Butyl Ether, Dipropylene Glycol n-Butyl Ether and the like and mixtures thereof)

Glycol Ether Esters (C₂-C₄ carboxylic acid esters of C₁-C₆ alkyl monoethers of C₂-C₉ alkylene glycols such as Diethylene Glycol Methyl Ether Acetate, Ethylene Glycol Methyl Ether Acetate, Propylene Glycol Methyl Ether Acetate, Ethylene Glycol Butyl Ether Acetate, Ethylene Glycol Ethyl Ether Acetate, Ethylene Glycol Ethyl Ether Butyrate, and the like and mixtures thereof)

Ketones (Acetyl Acetone, Methyl Ethyl Ketone, Methyl Isoamyl Ketone and the like and mixtures thereof)

Lactams (piperidones such as N-Methyl Piperidone, N-Ethyl Piperidone, Dimethyl Piperidone, Diethyl Piperidone, Dimethoxy Piperidone, Diethoxy Piperidone and cyclohexyl analogues of these piperidones such as N-Methyl-2-Pyrrolidone, N-Ethyl-2-Pyrrolidone, N-(2-Hydroxyethyl)-2-Pyrrolidone, N-2(Cyclohexyl)-2-Pyrrolidone and the like and mixtures thereof)

Sulfur based solvents (Dimethyl Sulfoxide, Sulfolane and the like and mixtures thereof).

It should be noted that preferred components for the co-solvent mixture are ones that ensure that the supercritical cleaning of the substrate is accomplished at a given pressure without the need for pressure cycling.

The oxidizer is preferably selected from the group of: hydrogen peroxide (H₂O₂), benzoyl peroxide, halogens, nitrogen trifluoride, an organic peracid, an organic hydroperoxide, oxygen, ozone, a perborate, a percarbonate, a persulfate, sulfur dioxide, sulfur trioxide and urea peroxide. Hydrogen peroxide having a concentration of 10-80%, and most preferably 10-50%, is particularly suitable for the process. Hydrogen peroxide is preferred because of low cost, its availability as a high purity reagent throughout the world and because its only decomposition products are the environmentally friendly water and oxygen gas. Hydrogen peroxide has a high active oxygen content due to its low molecular weight, which makes it an efficient oxidant. It can be used in both aqueous and organic media, often using low excesses of the reagent and because its concentration can be maintained by combining it with a carbonate or a mixture of carbonates. Mixtures of peroxides and carbonates (alkylene or dialkyl) have been found to make a stable, single phase solution. Marquis et al. in U.S. Pat. Nos. 6,040,284 and 6,239,090 describe a number of single-phase solutions that are formed by mixing peroxides and carbonates in different ratios that are stable in composition. In addition, these solutions are non-flammable, of low volatility and free of carcinogenic chemicals. Normally concentrated solutions of hydrogen peroxide and water are handled carefully as the peroxide is a strong oxidizer and could pose a hazard. However, mixing hydrogen peroxide and carbonate causes the concentration of hydrogen peroxide to decrease (in the overall mix) thereby decreasing the hazardous nature of the final composition.

It is worth noting that when one or more organic solvents are added to the peroxide, water and carbonate mixture, at room and at temperatures up to 50° C., a single-phase solution is maintained for long periods of time. This ensures that the oxidative power of the co-solvent mix is retained for a long time that and the efficacy of the mix to attack and dissolve cross-linked photoresists does not diminish with time. This is in direct contrast with the usual peroxide solutions used in the semiconductor (and other) industries where peroxide concentration in aqueous solutions decreases with time, the peroxide decomposition being accelerated with increasing temperatures.

Various other ingredients, known to those skilled in the art, may be blended into the co-solvent mixture. These include additional buffering agents, corrosion inhibitors, chelating agents, surfactants and the like or may directly be used to effect photoresist and/or photoresist residue removal in a scCO₂ system.

According to another aspect of the invention, an accelerator may be used to increase the stripping activity and attack particularly resistant types of photoresist and/or resist residue. Exemplary accelerators include C₁-C₂₂ carboxylic acids (e.g., formic, acetic, oxalic, citric, maleic, malic, lactic, glycolic, L-tartaric etc.), bases such as organoamines (e.g., diethanolamine, diglycolamine, ethylene diamine, isopropyl amine, monoethanol amine, morpholine, triethanolamine etc.), solvents such as lower alcohols (methanol, ethanol), ethers (1,3,5 Trixoane) or glycols (ethylene and propylene) and salts (ammonium carbamate, ammonium carbonate, ammonium formate, hydroxy propyl carbamate etc.). When these accelerators are used, it may also be desirable to incorporate a corrosion inhibitor or mixture of inhibitors to protect the substrate and the hardware of the cleaning apparatus. Examples of suitable corrosion inhibitor(s) are taught in open patent literature such as those described in U.S. Pat. Nos. 5,419,779, 5,556,482 & WO 00/44867 by Ward and co-workers; U.S. Pat. Nos. 5,665,688 and 5,798,323 by Honda and co-workers; U.S. Pat. No. 5,792,274 by Tanabe et al.; U.S. Pat. No. 6,191,086 by Leon et al., U.S. Pat. Nos. 6,235,693 and 6,248,704 by Cheng, Small and co-workers, U.S. Pat. No. 6,384,001 by Hineman and Blalock and U.S. Pat. No. 6,475,966 by Sahbari; all of which are incorporated herein by reference. The inhibitor(s) are typically present in an amount from 0.1 to about 5 weight %, based on the total weight of the composition.

It is understood, by those skilled in the art, that chelating agents and inhibitors have similar functions but they are not necessarily the same. A chelating agent can play one or more roles by stabilizing the reaction products and preventing their precipitation on the wafer and/or processing hardware surface or stabilize the various component(s) of the co-solvent composition mixture or act as a corrosion inhibitor. A chelating agent may also help remove ionic and anionic contamination from the wafer surface by dissolving the contamination into the co-solvent mixture. Suitable examples are generally commercially available and are also taught in the open patent literature cited above. The chelating agents are typically present in an amount from 0.1 to about 5 weight %, based on the total weight of the composition.

An aqueous fluoride may be added to the first co-solvent 1 mixture. In this embodiment, the supercritical CO₂, the solvent, the oxidizer and the aqueous fluoride remove the photoresist and/or resist residue generated in an etching or ashing step. Preferably, the aqueous fluoride is selected from the group of fluoride bases and fluoride acids. More preferably, the aqueous fluoride is selected from the group consisting of aqueous ammonium fluoride (NH₄F), ammonium bifluoride and aqueous hydrofluoric acid (HF).

Exposure of a substrate to the first co-solvent mixture may be followed by a subsequent process step in which a supercritical fluid carries a second co-solvent (“co-solvent 2”) into contact with the substrate and into high aspect vias. In this subsequent step, the second co-solvent removes the co-solvent 1 mixture and any by-products, and rinses and dries the substrate. Preferably, the second co-solvent is selected from the group of lower monohydroxy alcohols such as Methanol, Ethanol and Propanol, isomers of these alcohols and mixtures thereof. Alternatively, different mixtures of alcohol and water may also be used. The mixture of alcohol and water may use a single alcohol or blends of multiple alcohols added to water in different ratios.

In a first embodiment, the first co-solvent mixture (hereinafter the “co-solvent 1 mixture”) includes a carbonate, Dimethyl Sulfoxide (“DMSO”), and hydrogen peroxide, and the second co-solvent mixture (hereinafter “co-solvent 2 mixture”) includes isopropyl alcohol. As discussed, inclusion of carbonates in the mixture helps to maintain the stability of the co-solvent 1 mixture. Preferred carbonates for this and the following embodiments are Ethylene Carbonate, Propylene Carbonate, 1,2-Butylene Carbonate and various carbonate blends such as EC-25, EC-50 and EC-75 commercially available from Huntsman Corporation, Houston, Tex. Preferred ranges include (by weight) 10-60% of the carbonate (e.g. Ethylene Carbonate, Propylene Carbonate, 1,2-Butylene Carbonate and various carbonate blends such as EC-25, EC-50 or EC-75), 10-45% DMSO, and 10-50% of hydrogen peroxide, where the concentration of the hydrogen peroxide ranges from 10-80%.

In a second embodiment, the co-solvent 1 mixture includes a carbonate, Benzyl Alcohol (“BA”), and hydrogen peroxide, and the co-solvent 2 mixture includes isopropyl alcohol. Preferred ranges include (by weight) 10-60% of the carbonate, 10-60% Benzyl Alcohol, and 10-50% of hydrogen peroxide, where the concentration of the hydrogen peroxide ranges from 10-80%

In yet a third embodiment, the co-solvent 1 mixture includes a carbonate, Dimethyl Sulfoxide, hydrogen peroxide and ammonium fluoride, and the co-solvent 2 mixture includes isopropyl alcohol. Preferred ranges include (by weight) 10-60% of the carbonate, 10-45% DMSO, and 10-50% of hydrogen peroxide, where the concentration of the hydrogen peroxide ranges from 10-80%, together with 0.05-3.0% of 40% ammonium fluoride.

A fourth embodiment adds an accelerator to the co-solvent 1 mixtures of the 1^{st}, 2^{nd} or 3^{rd} embodiments. Preferred accelerators include both acidic accelerators such as formic acid, acetic acid, citric acid, lactic acid, L-Tartaric acid, maleic acid, malic acid, oxalic Acid, phosphoric acid, sulfuric acid, solvent accelerators such as methanol, ethanol, ethylene glycol, propylene glycol and alkaline accelerators such as ethylene diamine, monoethanolamine (MEA), triaethanolamine (TEA), Diglycolamine (DGA) etc. Preferred ranges of components for the co-solvent 1 mixture include (by volume) 10 to 60% PC, 10 to 60% BA, 1 to 50% accelerator and 10 to 50% of hydrogen peroxide, where the concentration of the hydrogen peroxide ranges from 10 to 80%. In one variation, a combination of formic acid and phosphoric acid may be used to accelerate the process, in which case preferred ranges by volume are 10 to 60% PC, 10 to 60% BA, 1 to 50% acetic or formic acid, 1-10% Phosphoric acid and 10 to 50% of H₂O₂ where the concentration of the hydrogen peroxide ranges from 10 to 80%. It should be noted that sulfuric acid may be substituted for the phosphoric acid. It should also be noted that these embodiments may be practiced without the use of an oxidizer (i.e. hydrogen peroxide), although as illustrated in the examples, certain accelerators (e.g. alkaline accelerators MEA, TEA and diethanolamine (DEA)) find their effectiveness when the oxidizer is present.

In a fifth embodiment, the co-solvent 1 mixture includes a carbonate, Benzyl Alcohol, formic acid, and an accelerator (such as hydroxyl propyl carbamate (“HPC”), a 1:1 mixture of ammonium acetate and DI water, or propylene glycol) as well as hydrogen peroxide, and the co-solvent 2 mixture includes isopropyl alcohol. Preferred ranges include (by volume) 5-50% of the carbonate, 5-50% Benzyl Alcohol, 5-50% Formic Acid, 5-50% other accelerator (e.g. HPC), and 5-50% of hydrogen peroxide, where the concentration of the hydrogen peroxide ranges from 10-80%. In this embodiment, acetic and/or maleic acid may be used in place of the formic acid.

In a sixth embodiment, the co-solvent 1 mixture includes a carbonate, Benzyl Alcohol, hydroxyl propyl carbamate (“HPC”) and hydrogen peroxide, and the co-solvent 2 mixture includes isopropyl alcohol. Preferred ranges include (by volume) 5-50% of the carbonate, 5-50% Benzyl Alcohol, 5-50% HPC, and 5-50% of hydrogen peroxide, where the concentration of the hydrogen peroxide ranges from 10-80%.

In a seventh embodiment, the co-solvent 1 mixture includes a carbonate, Benzyl Alcohol, Trioxane and hydrogen peroxide, and the co-solvent 2 mixture includes isopropyl alcohol. Preferred ranges include (by volume) 5-50% of the carbonate, 5-50% Benzyl Alcohol, 5-50% Trioxane, and 5-50% of hydrogen peroxide, where the concentration of the hydrogen peroxide ranges from 10-80%.

Embodiments Practiced at Ambient Pressure

scCO₂ process conditions accelerate photoresist stripping compared to processing done at ambient pressures. For example, as shown in the examples in this application, a 10,000′ thick blanket I-line photoresist that was hard baked at 110° C. for 90 s and at 160° C. for 60 s can be completely dissolved under scCO₂ conditions of 2400 psi and 100° C. in 4 minutes using a mixture of propylene carbonate, dimethyl sulfoxide and hydrogen peroxide. The same photoresist/solvent solution combination took 47 minutes to dissolve the same photoresist on a hot plate at ambient pressure/15 psi and 80° C. In this example the scCO₂ conditions accelerated the photoresist stripping rates by over an order of magnitude. This is because the temperature and pressure conditions needed to obtain supercritical conditions increased the reaction kinetics and mass transport of the reactant and product species.

However, it has been found that co-solvent formulations developed by the present inventor are also quite effective for rapidly removing the photoresist at ambient pressures as well. Thus, in alternative embodiments, the substrate is exposed to the co-solvent 1 mixture at ambient pressure for a suitable time in order to effect satisfactory cleaning. Stirring, agitation, circulation, sonication or other techniques known in the art may optionally be used. Following this exposure, rinsing and drying of the wafer may be done by transferring the wafer to a supercritical chamber where a supercritical fluid carries a second co-solvent into contact with a substrate and its high-aspect vias, removing the co-solvent 1 mixture and any by-products and rinsing and drying the substrate. Alternately, rinsing and drying may be carried out in a different tank or the same tank using methods commonly known to those possessing ordinary skill in the art.

In embodiments carried out under ambient pressure, the co-solvents, oxidizers, buffering agents, corrosion inhibitors, chelating agents, surfactants, accelerators, and other components described above in connection with the supercritical embodiments may be used. For example, the 1^{st}-7^{th} embodiments described in connection with the supercritical processes may be used. For brevity, the description of these components will therefore not be repeated here. Where scCO₂ is not used and processing is done at ambient pressure, surfactants may be used as additives to the co-solvent composition to lower the surface tension of the composition in order to allow it to easily penetrate (and be removed from) the high aspect vias in sub-micron semiconductor device structures. The surfactant may be anionic, cationic, non-ionic or zwitterionic in nature. Examples of suitable surfactant(s) and the amount it is to be used in this invention are disclosed in, for example, Kirk Othmer, Encyclopedia of Chemical Technology, 3^{rd} Edition, Vol. 22 (John Wiley & Sons, 1983); Sislet and Wood, Encyclopedia of Surface Active Agents (Chemical Publishing Company, Inc., 1964); McCutcheon's Emulsifiers & Detergents, North American International Edition (McCutcheon Division, The MC Publishing Company, 1991); Ash, What Every Chemical Technologist Wants to Know About . . . Emulsifiers and Wetting Agents, Vol. 1 (Chemical Publishing Company, Inc., 1988); Tadros, Surfactants (Academic Press, 1984); Napper, Polymeric Stabilization of Colloidal Dispersion (Academic Press, 1983) and Rosen, Surfactants & Interfacial Phenomena, 2^{nd} Edition (John Wiley and Sons, 1989), all of which are incorporated herein by reference. Alternatively, examples of suitable surfactant(s) and the amounts to be used in this invention are taught in open patent literature such as those described in U.S. Pat. No. 4,592,787 by Johnson; U.S. Pat. No. 5,783,082 by DeSimone et al.; U.S. Pat. No. 5,863,346 by Michelotti, U.S. Pat. No. 6,147,002 by Kneer; U.S. Pat. No. 6,197,733 by Mikami et al.; U.S. Pat. No. 6,211,127 by Kim et al.; U.S. Pat. No. 6,261,745 by Tanabe et al.; U.S. Pat. No. 6,248,704 by Small et al., U.S. Pat. No. 6,398,875 by Cotte et al and U.S. Pat. No. 6,562,146 by DeYoung et al.; all of which are incorporated herein by reference.

Systems

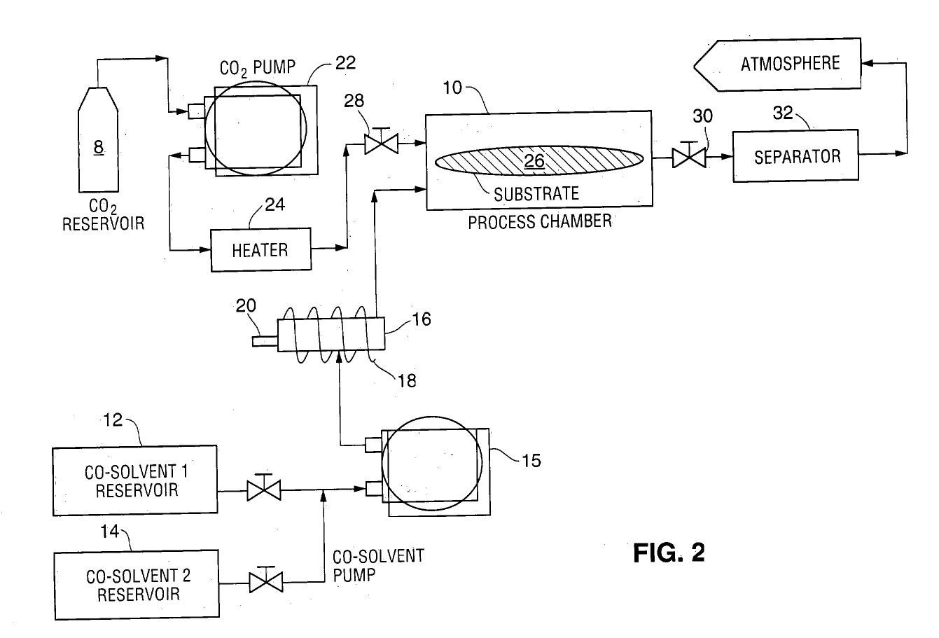

Systems for carrying out the described process may be configured in a variety of ways. One such system, which exposes the wafer to the co-solvent 1 mixture under supercritical conditions, is schematically shown in FIG. 2. The system includes a pressure chamber 10 capable of withstanding temperatures and pressures at or above the critical temperature and pressure of the supercritical substance to be used in the process. The pressure chamber 10 functions as the process chamber in which the substrate(s) are cleaned.

A supply of co-solvent 1 mixture is housed in first reservoir 12, and co-solvent 2 mixture is housed in a second reservoir 14. A co-solvent pump 15 is positioned to pump co-solvent from first and/or second reservoirs 12, 14 into a holding container 16, which is preferably heated by a heating tape 18. The temperature of the co-solvent in the holding container is measured by an internal RTD (resistive thermal device) probe 20. Carbon dioxide (or another substance which serves as the supercritical component in the process) is stored in reservoir 8. A pump 22 is provided for pumping the CO₂ into the system, through a heater 24, and into the pressure chamber 10. The pressure chamber 10 includes a drain that allows fluid to be exhausted from the chamber, and a pressure relief valve (not shown) that allows pressure within the chamber to be reduced. Valve 30 is fluidly coupled to a separator 32 that is vented to the atmosphere (the separator is at atmospheric pressure. The separator allows the photoresist and residue dissolved at high pressure to precipitate out at ambient pressure, and allows the co-solvents to be separated from the scCO₂ for potential re-use. The pressure chamber 10 also includes a heating system and appropriate temperature sensors and controllers (not shown) that function to prevent “over temperature” conditions. One or more system controllers (not shown) contains software programmed for the desired operations preferably control operation of the systems valves, pumps etc.

During use, co-solvent mixture is pumped into a holding container 16 and heated to a predetermined temperature by heating tape 18. A substrate 26, having photoresist and/or resist residue material that is to be removed is placed in pressure chamber 10 and the chamber is sealed. Next, the CO₂ is pumped from reservoir 8 through heater 24 (so as to heat the CO₂ to a predetermined temperature) and is introduced into pressure chamber 10. When the desired chamber pressure is achieved, the system software closes a valve 28 and prevents the flow of additional CO₂ into the system. From this time on, the chamber is preferably pressurized at the operating pressure. This operating pressure is preferably much greater than the critical pressure for CO₂ (1070 psi) and is typically on the order of 1800 psi.

When the co-solvent 1 chemistry in the holding container 16 has reached the predetermined temperature, it is introduced into the process chamber 10 where it contacts the substrate. After the substrate has been exposed to the co-solvent 1 mixture for the desired amount of time, the co-solvent 1 mixture may be rinsed from the substrate surface by using pure supercritical fluid directed onto the substrate. This is accomplished by opening a valve 30 that connects the process chamber 10 to a separator 32. The separator is vented to atmosphere by opening valve 30 to subject the fluid inside the pressure chamber 10 to a pressure differential, causing the fluid to flow from the pressure chamber into the separator 32. Valve 28 is simultaneously opened by the software routine to let fresh scCO₂ into the system such that the pressure inside the process chamber 10 is maintained.

After rinsing the process chamber 10 and substrate 26 in fresh scCO₂ (for a duration of, for example, 15 seconds), co-solvent 2 is also introduced into the process chamber 10 via the holding container 16 from the co-solvent 2 reservoir 12. Alternate cycles of (1) rinsing the process chamber 10 and substrate 26 in pure scCO₂ and (2) exposing the substrate to co-solvent 2 may be repeated to dry the wafer. During the entire duration of this rinsing phase, valve 30 is open to drain all the fluid contents of the process chamber 10 into the separator and valve 28 is open to let fresh scCO₂ into the system to maintain the system pressure. After the desired number of rinsing cycles of scCO₂ and co-solvent 2, valve 28 is closed and valve 30 is kept open to depressurize the chamber. After depressurization, a cleaned and dry photoresist and/or resist residue free substrate, 26, is removed from the process chamber 10.

Preferably, the pressure chamber is not de-pressurized between application of the co-solvent 1 mixture and application of the co-solvent 2 mixture. This allows the entire process to be performed as a single step, without pressure-cycling the system.

The substrate is supported within the pressure chamber in a manner that allows the front and/or front and back surfaces of the substrate to be exposed to fluids within the chamber. The pressure chamber may be configured to support a single substrate or multiple substrates.

The composition and methods described herein are highly beneficial in that they can achieve thorough stripping of photoresist materials. (including I-Line, DUV, 193 nm, BARC) and their photoresist residue (also called “post-ash residue”) created in a plasma chamber. Simultaneous removal of photoresist and photoresist residue is also possible using the compositions and method described in this application. The substrates treated using the disclosed compositions and methods may have various features which include (but are not limited to) aluminum metal lines; high dielectric (“high k”) gate materials such as hafnium oxide, platinum, zirconium oxide; high aspect vias, and/or features etched into copper/low k dielectric substrate materials. It should be noted that the term “integrated circuit device” may be used herein to describe integrated circuit devices in various stages of completion. Moreover, although semiconductor substrates are primarily discussed herein, the composition and method may also be used for other types of substrates, such as liquid crystal displays.

The near zero surface tension of the supercritical fluid and reduced surface tension of the co-solvent mix allow penetration of the supercritical fluid and/or the co-solvent into high aspect ratio structures that are commonly found in integrated circuits. Without complete co-solvent penetration, residue removal from the bottom and the sidewalls of high aspect ratio structures is not possible. This process has been shown to work for removing blanket photoresist films that may have been hardbaked (e.g. to drive off the solvent and improve the adhesion of the photoresist material to the substrate surface and/or the barrier layer). Some of the hardbaked photoresist may be further cross-linked under high intensity UV lamps to achieve 100% cross-linking of the photoresist. A 100% cross-linked photoresist structure improves the intended performance of the photoresist but makes the photoresist very difficult to remove.

In addition, the disclosed compositions and methods are suitable for use on substrates (including the photoresist covering part of the substrates) that were implanted with ions of Group III or Group V elements of the periodic table. This process is called doping and is intended to create surface layers, over certain select areas of the wafer, that have different conductivity from the bulk silicon substrate. Following the ion implantation step(s), the photoresist has a hard outer crust covering a jelly like core. The hard crust dissolves at a much slower rate than the underlying photoresist and therefore, implanted photoresists are considered some of the most challenging resists to remove. Typically, in the prior art, implant levels greater than 1×10¹⁴ atoms/cm² are removed by a two-step process requiring plasma ashing in an O₂ plasma followed by removal of residues created in the plasma process in a stripping bath. Using the disclosed compositions/methods of scCO₂ cleaning, one can remove very high implant levels photoresist (8×10¹⁵ atoms/cm²) and come out with a dry, photoresist free wafer surface in a single step that is less harsh on the environment and the substrate itself than the multi-step processes currently used in the industry.

If the substrates are to be exposed to the co-solvent 1 mixture at ambient pressure, the process may be carried out using any known means for exposing substrates to compositions, such as by placing one or more substrates in a vessel containing the composition or by spraying the composition onto the substrate(s). When the substrate is placed in a vessel, the substrate is preferably completely immersed in the composition. Stirring, agitation, circulation, sonication or other techniques known in the art may optionally be used. After the substrate has been exposed to the desired composition for a period of time sufficient to remove the photoresist and/or resist residue, exposure is terminated. Rinsing and drying of the substrate may be done by transferring the wafer to a supercritical chamber where a supercritical fluid carries a second co-solvent into contact with a substrate and its high-aspect vias, removing the first co-solvent and any by-products and rinsing and drying the substrate. Alternately, rinsing and drying may be carried out in a different tank or the same tank using methods commonly known to those possessing ordinary skill in the art.

### EXAMPLES

Following are examples describing experimental tests performed using compositions and methods disclosed above. It should be understood that these are intended as examples only, and are not intended to limit the scope of the claims. These examples are described in sufficient detail to enable those skilled in the art to practice the disclosed methods, and it is to be understood that changes to the substrate and chemical changes to the co-solvent 1 composition may be made without departing from the spirit and scope of the invention. Some of these examples were carried out using a test bed apparatus that differed from the apparatus of FIG. 2. Although a preferred apparatus would perform the disclosed method on an entire substrate or substrates, the test bed apparatus performed the described methods on a single die cut from a substrate. For this reason, it should be noted that the quantities of substances used and the exposure times given will differ for when one or more complete substrates are being treated.

### Example 1

In a first example, a substrate having a hard baked I-line photoresist that was DUV stabilized using UV lamps to achieve 100% cross-linking was placed in the process chamber. A co-solvent 1 composition of 40% (by weight) 1,2-Butylene Carbonate, 30% Dimethyl Sulfoxide, and 30% of 30% hydrogen peroxide was mixed at a temperature of 55° C.

The 1,2-Butylene Carbonate was selected for its high solvency and the fact that it makes a single-phase solution with hydrogen peroxide. Ethylene or Propylene Carbonate or blends of Ethylene and Propylene Carbonate may be substituted for the 1,2-Butylene Carbonate (and vice versa) in this and the following examples. The hydrogen peroxide was selected for its ability to attack the cross-linked bonds of the photoresist, and the dimethyl sulfoxide was selected for its ability to carry out photoresist stripping. This mixture was made to flow into the process chamber and onto the substrate at a rate of 8 g/min for approximately 90 seconds. Supercritical carbon dioxide was caused to flow into the chamber with the co-solvent 1 at a flow rate of 72 g/min to have a total fluid flow rate into the process chamber at 80 g/min. The temperature and pressure within the chamber were 110° C. and 165 bar, respectively. After 90 seconds, the flow of carbon dioxide into the chamber was suspended, and the flow rate of the co-solvent 1 was increased to 80 g/min for approximately 20 seconds.

Next, flow of co-solvent 1 was terminated and the back-pressure regulator was turned off, leaving the substrate in a static dwell of co-solvent and supercritical carbon dioxide at 165 bar and 110° C. to affect photoresist stripping. Although fluids may alternatively be made to flow through the chamber during the exposure period, a static dwell is preferable in that it minimizes chemical usage. The substrate was then allowed to dwell in the chamber for approximately 4 minutes and 40 seconds. After the dwell time, the back-pressure regulator was turned on, and supercritical carbon dioxide was allowed to flow onto the substrate to flush the first-co-solvent from the substrate for a period of 30 seconds.

Next, a second co-solvent consisting of isopropyl alcohol, at room temperature, was made to flow onto the substrate surface at a rate of 40 g/min, together with supercritical carbon dioxide which was also flowing into the chamber at 40 g/min, for a total fluid flow into the chamber of 80 g/min. This flow continued for approximately 90 seconds, after which the flow of the second co-solvent was terminated. Flow of supercritical carbon dioxide continued for an additional two minutes, after which the substrate was removed from the chamber. The substrate was found to be completely free of photoresist, and the substrate and the chamber were thoroughly dried.

### Example 2

In the second example, the co-solvent mix was unchanged but was introduced into the process chamber in higher amounts at the start of the run. The complete process was run without any static dwell in the process chamber. A substrate having a hard baked I-line photoresist that was DUV stabilized using UV lamps to achieve 100% cross-linking was placed in the process chamber. A co-solvent 1 composition of 40% (by weight) 1,2-Butylene Carbonate, 30% Dimethyl Sulfoxide, and 30% of 30% hydrogen peroxide was mixed at a temperature of 50° C. This mixture was made to flow into the process chamber and onto the substrate at a rate of 20 g/min for approximately 30 seconds. Supercritical carbon dioxide was caused to flow into the chamber with the co-solvent 1 at a flow rate of 60 g/min to have a total fluid flow rate into the process chamber at 80 g/min. Subsequently the co-solvent 1 flow rate was decreased to 2.4 g/min and the supercritical carbon dioxide flow rate increased to 77.6 g/min. for the next 3 minutes and 30 seconds. The operating temperature and pressure within the chamber were 110° C. and 165 bar, respectively.

Next, flow of co-solvent 1 was terminated and supercritical carbon dioxide, at a flow rate of 80 g/min., was allowed to flow onto the substrate to flush the first-co-solvent from the substrate for a period of 30 seconds.

Next, a second co-solvent consisting of isopropyl alcohol, at room temperature, was made to flow onto the substrate surface at a rate of 40 g/min, together with supercritical carbon dioxide which was also flowing into the chamber at 40 g/min. for a total fluid flow into the chamber of 80 g/min. This flow continued for approximately 90 seconds, after which the flow of the second co-solvent was terminated. Flow of supercritical carbon dioxide continued for an additional two minutes, after which the substrate was removed from the chamber. The substrate was found to be completely free of photoresist, and the substrate and the chamber were thoroughly dried.

### Example 3

The third example is similar to Example 2, but differs in that a different co-solvent 1 composition was used. A substrate having a hard baked I-line photoresist that was DUV stabilized using UV lamps to achieve 100% cross-linking was placed in the process chamber. A co-solvent 1 composition of 40% (by weight) 1,2-Butylene Carbonate, 40% Benzyl Alcohol, and 20% of 30% hydrogen peroxide was mixed at a temperature of 50° C. This mixture was made to flow into the process chamber and onto the substrate at a rate of 20 g/min for approximately 45 seconds. Supercritical carbon dioxide was caused to flow into the chamber with the co-solvent 1 at a flow rate of 60 g/min to have a total fluid flow rate into the process chamber at 80 g/min. Subsequently the co-solvent 1 flow rate was decreased to 2.4 g/min and the supercritical carbon dioxide flow rate increased to 77.6 g/min. for the next 3 minutes and 15 seconds. The operating temperature and pressure within the chamber were 110° C. and 165 bar, respectively.

Next, flow of co-solvent 1 was terminated and supercritical carbon dioxide, at a flow rate of 80 g/min., was allowed to flow onto the substrate to flush the first-co-solvent from the substrate for a period of 30 seconds.

Next, a second co-solvent consisting of isopropyl alcohol, at room temperature, was made to flow onto the substrate surface at a rate of 40 g/min, together with supercritical carbon dioxide which was also flowing into the chamber at 40 g/min for a total fluid flow into the chamber of 80 g/min. This flow continued for approximately 90 seconds, after which the flow of the second co-solvent was terminated. Flow of supercritical carbon dioxide continued for an additional two minutes, after which the substrate was removed from the chamber. The substrate was found to be completely free of photoresist, and the substrate and the chamber were thoroughly dried.

### Example 4

The fourth example utilized the same co-solvent 1 composition as used in Example 2, but the composition was used on a substrate having different characteristics. In this example, the blanket photoresist layer removed was a 6000 Å thick DUV 5 photoresist layer on top of a polysilicon layer which covers a silicon dioxide layer on top of the silicon wafer substrate. The photoresist was subjected to a high dose implant of boron at 10 keV to a dosage level of 3×10¹⁵ atoms/cm². A co-solvent 1 composition of 40% (by weight) 1,2-Butylene Carbonate, 30% Dimethyl Sulfoxide, and 30% of 30% hydrogen peroxide was mixed at a temperature of 50° C. This mixture was made to flow into the process chamber and onto the substrate at a rate of 8 g/min for 4 minutes. The co-solvent 1 mixture was carried into the process chamber by supercritical carbon dioxide at a flow rate of 72 g/min to have a total fluid flow rate into the process chamber at 80 g/min. The operating temperature and pressure within the chamber were 110° C. and 165 bar, respectively.

A 4-minute exposure of the photoresist film to the co-solvent 1 mixture was found to have completely dissolved the photoresist by visual observation (no edge exclusion was visible) and verified by ellipsometry.

Although the drying step was not performed, the result is expected to be the same as was achieved in Examples 1-3. The primary modification to Example 4 as compared with Example 2 was that the ion implant process created a level of organic contamination that traditionally has been more difficult to remove by liquid chemicals only.

### Example 5

The fifth example utilized the same co-solvent 1 composition as used in Example 2, but the composition was used on a substrate having different characteristics. The blanket photoresist layer removed was a 6000 Å thick DUV 5 photoresist layer on top of a polysilicon layer which covers a silicon dioxide layer on top of the silicon wafer substrate. The photoresist was subjected to a high dose implant of arsenic at 20 keV to a dosage level of 2×10¹⁵ atoms/cm². A co-solvent 1 composition of 40% (by weight) 1,2-Butylene Carbonate, 30% Dimethyl Sulfoxide, and 30% of 30% hydrogen peroxide was mixed at a temperature of 50° C. This mixture was made to flow into the process chamber and onto the substrate at a rate of 8 g/min for 5 minutes. The co-solvent 1 mixture was carried into the process chamber by supercritical carbon dioxide at a flow rate of 72 g/min to have a total fluid flow rate into the process chamber at 80 g/min. The operating temperature and pressure within the chamber were 110° C. and 165 bar, respectively.

A 5-minute exposure of the photoresist film to the co-solvent 1 mixture was found to have completely dissolved the photoresist by visual observation (no edge exclusion was visible) and verified by ellipsometry.

Although the drying step was not performed, the result is expected to be the same as was achieved in Examples 1-3. The primary modification to Example 5 as compared with Example 2 was the presence of a level of organic contamination that traditionally has been more difficult to remove by liquid chemicals only.

### Example 6

The sixth example utilized the same co-solvent 1 composition as used in Example 2, but the composition was used on a substrate having different characteristics. The blanket photoresist layer removed was a 6000 Å thick DUV 5 photoresist layer on top of a polysilicon layer which covers a silicon dioxide layer on top of the silicon wafer substrate. The photoresist was subjected to a high dose implant of arsenic at 10 keV to a dosage level of 3×10¹⁵ atoms/cm². A co-solvent 1 composition of 40% (by weight) 1,2-Butylene Carbonate, 30% Dimethyl Sulfoxide, and 30% of 30% hydrogen peroxide was mixed at a temperature of 50° C. This mixture was made to flow into the process chamber and onto the substrate at a rate of 8 g/min for 6 minutes. The co-solvent 1 mixture was carried into the process chamber by supercritical carbon dioxide at a flow rate of 72 g/min to have a total fluid flow rate into the process chamber at 80 g/min. The operating temperature and pressure within the chamber were 110° C. and 165 bar, respectively.

A 6-minute exposure of the photoresist film to the co-solvent 1 mixture was found to have completely dissolved the photoresist by visual observation (no edge exclusion was visible) and verified by ellipsometry.

Although the drying step was not performed, the result is expected to be the same as was achieved in Examples 1-3. The primary modification to Example 6 as compared with Example 2 was the presence of a level of organic contamination that traditionally has been more difficult to remove by liquid chemicals only.

### Example 7

The seventh example utilized the same co-solvent 1 composition as used in Example 2, but the composition was used on a substrate having different characteristics. The blanket photoresist layer removed was a 6000 Å thick DUV 5 photoresist layer on top of a polysilicon layer which covers a silicon dioxide layer on top of the silicon wafer substrate. The photoresist was subjected to a high dose implant of arsenic at 5 keV to a dosage level of 5×10¹⁵ atoms/cm². A co-solvent 1 composition of 40% (by weight) 1,2-Butylene Carbonate, 30% Dimethyl Sulfoxide, and 30% of 30% hydrogen peroxide was mixed at a temperature of 50° C. This mixture was made to flow into the process chamber and onto the substrate at a rate of 8 g/min for 6 minutes. The co-solvent 1 mixture was carried into the process chamber by supercritical carbon dioxide at a flow rate of 72 g/min to have a total fluid flow rate into the process chamber at 80 g/min. The operating temperature and pressure within the chamber were 110° C. and 165 bar, respectively.

A 6-minute exposure of the photoresist film to the co-solvent 1 mixture was found to have completely dissolved the photoresist by visual observation (no edge exclusion was visible) and verified by ellipsometry.

Although the drying step was not performed, the result is expected to be the same as was achieved in Examples 1-3. The primary modification to Example 7 as compared with Example 2 was the presence of a level of organic contamination that traditionally has been more difficult to remove by liquid chemicals only.

### Example 8

The substrate used in the eighth example included a via structure which contained a low k dielectric layer. Prior to the experiment, photoresist was removed using an asher, leaving post-ash residues in the via structure. The specific chemistry employed was the following: 39.93% (by weight) 1,2-Butylene Carbonate, 39.93% Dimethyl Sulfoxide, and 29.94% of 30% hydrogen peroxide and 0.2% of 40% ammonium fluoride. This mixture was made to flow into the process chamber and onto the substrate at a rate of 8 g/min for 5 minutes. The co-solvent 1 mixture was carried into the process chamber by supercritical carbon dioxide at a flow rate of 72 g/min to have a total fluid flow rate into the process chamber at 80 g/min. The operating temperature and pressure within the chamber were 43° C. and 165 bar, respectively.

A 5-minute exposure of the post ash residues to the co-solvent 1 mixture was found to have completely dissolved and removed the post ash by SEM analysis. SEM photo of various die locations showed that complete residue removal was achieved with no attack of the semiconductor structure geometries.

Although the drying step was not performed, the result is expected to be the same as was achieved in Examples 1-3. The primary modification to Example 8 as compared with Example 2 was the type of organic contamination (post ash residue) that had to be removed.

### Example 9

Formic Acid Free Formulations

For resist stripping, various photoresist stripper compositions were prepared as indicated in Table 1. In this example, these compositions were used in a scCO₂ apparatus under much more severe conditions than previously described. It is emphasized that all of the concentrations specified in all the tables in this application are based on the total composition.

The compositions of Table 1 were applied to a substrate having a 10,000′ thick, completely cross-linked, blanket I-line photoresist at supercritical conditions as described below. The co-solvent 1 mixture was made to flow into the process chamber and onto the substrate at a rate of 40 g/min for approximately 40 seconds. Supercritical carbon dioxide was caused to flow into the chamber with the co-solvent 1 at a flow rate of 40 g/min to have a total fluid flow rate into the process chamber at 80 g/min. The temperature and pressure within the chamber were 110° C. and 2400 psi (165 bar), respectively. After 40 seconds, the co-solvent 1 flow rate was decreased to 4.0 g/min and the supercritical carbon dioxide flow rate increased to 76 g/min. for the remainder of the stripping time (typically a total of 4 minutes, unless noted otherwise). The process chamber was then de-pressurized to ambient pressure, the substrate removed and examined for photoresist removal optically and by ellipsometry. Optically a visible color change from a green-colored photoresist covered substrate to a silver-colored photoresist-free substrate could be clearly seen. It must be noted that although the drying step was not performed, the result is expected to be the same as was achieved in Examples 1-3.

TABLE 1
Co-Solvent Compositions Used at Supercritical Conditions

| | | | Shortest Time for Complete |
|---|---|---|---|
| Alkylene Carbonate | Hydrogen Peroxide | Other Chemical | Stripping |
| 40% PC | 20% of 30% H₂O₂ | 40% BA | Complete stripping in t where 3 min, |
| | | | 30 s < t ≦ 4 min. |
| 40% PC | 20% of 50% H₂O₂ | 40% BA | Complete stripping in t where 3 min, |
| | | | 30 s < t ≦ 4 min. |
| 40% EC-50 | 20% of 50% H₂O₂ | 40% BA | Complete stripping in t where 3 min, |
| | | | 30 s < t ≦ 4 min. |
| 32% PC | 20% of 50% H₂O₂ | 48% BA | Complete stripping in t where t > 5 min. |

BA = Benzyl Alcohol
BC = 1,2-Butylene Carbonate
EC-50 = Mix of 50% Ethylene Carbonate and 50% Propylene Carbonate commercially available from Huntsman Corporation, Houston, Texas
PC = Propylene Carbonate

Table 1 shows that benzyl alcohol and alkylene carbonate make a very aggressive photoresist stripping composition which dissolves the photoresist into the composition rather than undercutting it such that it floats away in the solution as is the case with commercial photoresist strippers. Changing the alkylene carbonate used or the concentration of the hydrogen peroxide used made little difference in the stripping time.

Other experimental runs suggested that a composition using 48% PC, 20% hydrogen peroxide, and 32% BA will also achieve stripping at supercritical conditions, although at slightly longer exposure time (i.e. more then 4.5 minutes).

To achieve even faster stripping times than shown in Table 1, additional runs were performed for which the co-solvent compositions included various acid and alkaline accelerators. The challenge substrate (10,000′ thick, completely cross-linked I-line photoresist) was exposed to the various co-solvent compositions, shown in Table 2, under supercritical conditions in the manner detailed above.

TABLE 2
Co-Solvent Compositions With Non-Formic Acid Accelerators Used at Supercritical Condition

| PC | BA | 50% H₂O₂ | Other Chemical(s) | Shortest Time for Complete Stripping |
|---|---|---|---|---|
| 35% | 35% | 20% | 10% Acetic Acid | Complete stripping in t where 2 min. < t ≦ 2 min., |
| | | | | 30 s |
| 35% | 35% | 20% | 10% Citric Acid | Complete stripping in t where 3 min. < t ≦ 3 min., |
| | | | | 30 s |
| 35% | 35% | 20% | 5% Acetic Acid + 5% | Complete stripping in t where 3 min., |
| | | | Citric Acid | 30 s < t ≦ 5 min. |
| 35% | 35% | 20% | 10% Ethyl Lactate | Complete stripping in t where 5 min. < t ≦ 5 min., |
| | | | | 30 s |
| 35% | 35% | 20% | 10% Glycolic Acid | Complete stripping in t where 5 min. < t ≦ 6 min. |
| 35% | 35% | 20% | 10% Lactic Acid | Complete stripping in t where 4 min. < t ≦ 6 min. |
| 35% | 35% | 20% | 10% L-Tartaric | Complete stripping in t where 3 min. < t ≦ 3 min., |
| | | | Acid | 30 s |
| 35% | 35% | 20% | 10% Maleic Acid | Complete stripping in t where t ≦ 1 min., |
| | | | | 30 s |
| 35% | 35% | 20% | 10% Malic Acid | Complete stripping in t where 3 min., |
| | | | | 30 s < t ≦ 4 min. |
| 35% | 35% | 20% | 10% Oxalic Acid | Complete stripping in t where 3 min. < t ≦ 3 min., |
| | | | | 30 s |
| 35% | 35% | 20% | 10% Anisole | Complete stripping in t where 6 min. < t ≦ 6 min., |
| | | | | 30 s |
| 35% | 35% | 20% | 10% Hexylene | Complete stripping in t where 5 min. < t ≦ 6 min. |
| | | | Glycol | |
| 35% | 35% | 20% | 10% Methanol | Complete stripping in t where t ≦ 3 min., |
| | | | | 30 s |
| 35% | 35% | 20% | 10% Ethanol | Complete stripping in t where 3 min. < t ≦ 3 min., |
| | | | | 30 s |
| 35% | 35% | 20% | 10% Ethylene | Complete stripping in t where t ≦ 3 min., |
| | | | Glycol | 30 s |
| 35% | 35% | 20% | 10% Dipropylene | Complete stripping in t where 6 min. < t ≦ 7 min. |
| | | | Glycol | |
| 43.75% | 43.75% | — | 12.5% Ethylene | Complete stripping in t where t ≦ 3 min., |
| | | | Diamine | 30 s |
| 35% | 35% | 20% | 10% | Complete stripping in t where 1 min. < t ≦ 1 min., |
| | | | Monoethanolamine | 30 s |
| 35% | 35% | 20% | 10% | Complete stripping in t where t ≦ 30 s. |
| | | | Triethanolamine | |
| 35% | 35% | 20% | 10% Diglycolamine | Complete stripping in t where t = 1 min. |

Among the solutions that achieved the fastest strip rates were those compositions that used carboxylic acid accelerators such as acetic and maleic acids, and those that used organoamines as accelerators. A number of the organoamines tested as accelerators did accelerate the process; the amines used were primary amines such as monoethanol amine (MEA), secondary amines such as ethylene diamine (EDA) and tertiary amines such as triethanolamine (TEA). The ethylene diamine solution did not require an oxidizer to accomplish stripping.

It must be pointed out that the testbed setup took about ˜40 s to build up to supercritical pressure and about ˜90 s to achieve 2400 psi. Any solutions that stripped in time less than 40 s did not achieve supercritical pressure and those that stripped in less than 90 s did not achieve 2400 psi pressure. As the results in Table 2 show, some of the solutions using accelerators were aggressive and did not require achieving supercritical pressures to complete the stripping. These solutions were specially chosen for testing at ambient pressure as described in later examples.

Several of the compositions disclosed here have desirable characteristics. For example, compositions containing PC, BA and hydrogen peroxide have low volatility, high boiling and flash points, high efficacy in photoresist stripping. They also use environmentally friendly compounds such as propylene carbonate which breaks down into non-toxic propylene glycol, and hydrogen peroxide which breaks down into water and oxygen gas. The acidic accelerators (e.g. acetic acid), which are used in certain embodiments, are also environmentally friendly given that their final decomposition products are water and carbon dioxide gas. International Patent WO 02/078441 by Stride et al. lists a number of references that show the very low toxicity of propylene and butylene carbonates. While the amines used in some of the formulations are toxic in nature and need not be used when environmentally friendly alternatives such as carboxylic acids are present, it may not always be possible to exclude toxic materials. For example, in many IC manufacturing steps, the wafer is exposed to fluorine containing gases and after processing has fluorine based compounds on the wafer surface. It may thus be necessary to include a source of fluoride ions (which are toxic) to the co-solvent 1 mixture if needed to remove fluorine compounds from the wafer surfaces. Fluorine, being the strongest oxidizer known to man, is extraordinarily difficult to remove from the wafer surface. Although Example 15 below describes a new process that removes fluorine plasma generated residues without using fluoride ions, conventional stripper formulations used at ambient and supercritical pressures have necessarily included a source of fluorine ions for such residue removal.

Similarly it is understood that while most of the favored components which are used in the preferred non-toxic and biodegradable compositions described herein are themselves substantially non-toxic and biodegradable, it is not required that all components be non-toxic and biodegradable. One of ordinary skill in the art will recognize that toxic and/or non-biodegradable components may be added to the preferred compositions of this invention without materially altering the unique and novel characteristics of these compositions.

### Example 10

Formic Acid Containing Formulations

Given the success of propylene carbonate and hydrogen peroxide based solutions when used with acetic acid as an accelerator, further testing was done by replacing acetic acid with formic acid as the accelerator. Various compositions, containing formic acid, were prepared as shown in Table 3 and tested according to the procedure detailed in Example 9.

TABLE 3
Formic Acid Containing Co-Solvent Compositions Used at Supercritical Conditions

| PC | BA | 50% H₂O₂ | Formic Acid | Shortest Time for Complete Stripping |
|---|---|---|---|---|
| 32.5% | 32.5% | 20% | 15% | Complete stripping in t where t ≦ 30 s |
| 35% | 35% | 20% | 10% | Complete stripping in t where t ≦ 30 s |
| 37% | 37% | 20% | 6% | Complete stripping in t where t ≦ 30 s |
| 30% | 40% | 15% | 15% | Complete stripping in t where t ≦ 30 s |
| 30% | 30% | 20% | 20% | Complete stripping in t where t ≦ 30 s |
| 25% | 25% | 20% | 30% | Complete stripping in t where t ≦ 30 s |
| 20% | 20% | 20% | 40% | Complete stripping in t where t ≦ 30 s |
| 40% | 40% | — | 20% | Incomplete stripping in t where t > 5 min., |
| | | | | 10 s |
| 30% | 30% | — | 40% | Incomplete stripping in t where t > 10 min. |
| 20% | 20% | 30% | 30% | Complete stripping in t where t ≦ 30 s |
| 15% | 15% | 30% | 40% | Complete stripping in t where t ≦ 30 s |

A comparison of Tables 2 and 3 shows that formulations containing formic acid and hydrogen peroxide strip at a faster rate than those containing acetic acid and hydrogen peroxide. The formic acid formulations in fact achieve stripping at rates in excess of 20,000 Å/min. Table 3 results further suggest that the presence of hydrogen peroxide is important for maximizing the stripping rate of the formic acid composition. Without being bound by any particular theory, it is currently believed that the formation of a peracid contributes directly to the effectiveness of this method for dissolving the photoresist. The peracid formation reaction is shown:

RCOOH+HO—OH [symbol] RCOOOH+H—OH (H₂O)

where R is a H or a linear, cyclic alkyl group or aromatic group. Peracids can also be prepared by reacting hydrogen peroxide with an acyl halide, a carboxylic acid anhydride, an amide, a dialkyl phosphate, N-acylimidazoles, an aromatic aldehyde, lipase catalyst or esters. Typically H or lower linear alkyl groups that result in carboxylic acids are preferred. Among the carboxylic acids, formic and trifluoroacetic acid can form peracids at room temperature while the formation of peracetic acid can be catalyzed by slight heating or acidification with sulfuric, sulfonic or phosphoric acids. Formic and acetic acids are preferred in the disclosed embodiments because they are available worldwide in high purity grades in large quantities and at low cost and because the final decomposition products of performic acid are carbon dioxide gas and water.

It is worth noting that the compositions disclosed in Table 3 may possess some inherent instability in composition and should preferably be pre-mixed right before commencing the stripping operation. If a more stable stripping composition is desired, ethylene diamine may be added to a mixture of propylene carbonate and benzyl alcohol (as shown in Table 2) to form a composition that does not contain any oxidizer and also gives high stripping rates. Although ethylene diamine reacts with the propylene carbonate, the reaction product is stable in composition and gives high stripping rates. An example of a stable co-solvent 1 composition that generates in-situ peracid is given later on in this application in Example 16.

### Example 11

Ambient Pressure Testing

Given the unexpected success of formic acid containing compositions in giving high stripping rates, it was decided to test these compositions to determine the stripping rates at ambient pressure. Various compositions were prepared as shown in Tables 4-7 and stripping times were recorded. Table 4 lists the stripping rates of the 10,000′ thick, completely cross-linked, blanket I-line photoresist, described in Example 9, at ambient temperature and pressure in an unstirred 100 ml beaker using acidic accelerators.

TABLE 4
Various Co-Solvent Compositions With Acidic Accelerators Used At Ambient
Temperature and Pressure Conditions

| PC | BA | 50% H₂O₂ | Other Chemical | Stripping Time (hr:min:s) |
|---|---|---|---|---|
| 37% | 37% | 20% | 6% Formic Acid | Layer by layer photoresist stripping |
| | | | | in t where 78:12:00 < t < 90:00:00 |
| 35% | 35% | 20% | 10% Formic Acid | Layer by layer photoresist stripping |
| | | | | in t where 78:12:00 < t < 90:00:00 |
| 30% | 30% | 20% | 20% Formic Acid | Layer by layer photoresist stripping |
| | | | | in t where 27:24:00 < t < 68:28:00 |
| 35% | 35% | 20% | 10% Acetic Acid | Layer by layer photoresist stripping |
| | | | | in t where 368:20:00 < t < 389:10:00 |
| 100% | — | — | — | No visual sign of attack after 2000 h |
| 40% | 40% | 20% | — | Layer by layer photoresist stripping |
| | | | | in t where 993:57:00 < t < |
| | | | | 1033:13:00 |
| 40% | 40% | — | 20% Formic Acid | Incomplete layer by layer photoresist |
| | | | | stripping after 2000+ hours |
| 30% | 30% | — | 40% Formic Acid | Incomplete layer by layer photoresist |
| | | | | stripping after 2000+ hours |
| 20% | 20% | 30% | 30% Formic Acid | Layer by layer photoresist stripping |
| | | | | in t where 8:14:00 < t < 29:14:00 |
| 15% | 15% | 40% | 40% Formic Acid | Layer by layer photoresist stripping |
| | | | | in t where 8:14:00 < t < 29:14:00 |
| 29% | 29% | 20% | 20% Formic Acid + 2% | Layer by layer photoresist stripping |
| | | | Phosphoric Acid | in t where 24:00:00 < t < 31:40:00 |
| 28% | 28% | 20% | 20% Formic Acid + 4% | Layer by layer photoresist stripping |
| | | | Phosphoric Acid | in t where 31:40:00 < t < 48:45:00 |
| 23% | 23% | 25% | 25% Formic Acid + 4% | Layer by layer photoresist stripping |
| | | | Phosphoric Acid | in t where 27:03:00 < t < 44:07:00 |

A comparison of the peroxide-containing formulations of Table 4 with the non-peroxide formulations suggests that the stripping rates are accelerated by peracid formation. Table 4 data further illustrates that formic acid formulations strip faster than acetic acid ones indicating that formic acid forms a particularly strong peracid. The stripping rates show a monotonic relationship with the amount of formic acid contained in the composition with the fastest rates achieved with the highest amount of performic acid formed. Due to the experiments occurring over a period of days, weeks and months, the precise time for stripping could not be determined. Hence the expected acceleration in stripping rates by the addition of phosphoric acid to the performic compositions is not clear.

The photoresist stripping (PRS) results obtained by using alkaline accelerators are shown in Table 5.

TABLE 5
Various Co-Solvent Compositions Containing Alkaline Accelerators
Used At Ambient Temperature and Pressure Conditions

| PC | BA | 50% H₂O₂ | Other Chemical | Stripping Time (hr:min:s) |
|---|---|---|---|---|
| 35% | 35% | 20% | 10% MEA | Layer by layer PRS in t where |
| | | | | 3:46:00 < t < 4:40:00 |
| 35% | 35% | 20% | 10% Diglycolamine | Layer by layer PRS in t where |
| | | | | 4:40:00 < t < 25:03:00 |
| 35% | 35% | 20% | 10% TEA | Layer by layer PRS in t where |
| | | | | 27:24:00 < t < 68:28:00 |
| 43.75% | 43.75% | — | 12.5% MEA | Incomplete layer by layer PRS after |
| | | | | 1650+ hours |
| 43.75% | 43.75% | — | 12.5% DEA | Incomplete layer by layer PRS after |
| | | | | 1650+ hours |
| 43.75% | 43.75% | — | 12.5% Diglycolamine | Incomplete layer by layer PRS after |
| | | | | 1650+ hours |
| 43.75% | 43.75% | — | 12.5% EDA | Incomplete layer by layer PRS after |
| | | | | 1650+ hours |
| 100% | — | — | — | No visual sign of attack after 2000 h |
| — | — | — | 100% TEA | Incomplete layer by layer PRS in |
| | | | | 2000+ hours |
| — | — | — | 100% MEA | Layer by layer PRS in t where |
| | | | | 7:48:00 < t < 22:42:00 |
| — | — | — | 100% Diglycolamine | Layer by layer PRS in t where |
| | | | | 7:48:00 < t < 22:42:00 |
| — | — | — | 100% EDA | Layer by layer PRS 99+% complete |
| | | | | in t where t < 4:00:00 |
| 40% | 40% | 20% | — | Layer by layer PRS in t where |
| | | | | 993:57:00 < t < 1033:13:00 |

Neat amine solutions such as MEA, Diglycolamine and EDA have the highest strip rates and when they are used as accelerators for the PC/BA/H₂O₂ solutions they significantly increase the stripping rate. Hydrogen peroxide is shown to be a desirable ingredient in the composition and significantly contributes to dissolution of the photoresist accelerating a slow acting amine such as TEA. Given that most of these amines are toxic in their pure form, addition of small amounts of amines to accelerate mixtures of PC, BA and H₂O₂ is a desirable means for producing more environmentally friendly strippers.

Tables 6 and 7 show the effect of temperature on the stripping rates. The photoresist-coated substrate was exposed to stripper formulations in a 100 ml beaker on a hot plate at 80° C. at ambient pressure. Results for acidic accelerators are shown in Table 6 and for alkaline accelerator in Table 7, respectively.

TABLE 6
Various Co-Solvent Compositions, Containing Acidic Accelerators, Heated On A Hot
Plate At 80° C. and Ambient Pressure Conditions

| PC | BA | 50% H₂O₂ | Other Chemical | Stripping Time (hr:min:s) |
|---|---|---|---|---|
| 37% | 37% | 20% | 6% Formic Acid | 0:0:48 to undercut photoresist |
| | | | | Without stirring took 0:15:40 to |
| | | | | digest undercut PR |
| 35% | 35% | 20% | 10% Formic Acid | 0:1:06 to undercut photoresist |
| | | | | With stirring @ 500 rpm, took |
| | | | | 0:08:30 to digest undercut PR |
| 30% | 30% | 20% | 20% Formic Acid | 0:0:39 to undercut photoresist |
| | | | | With stirring @ 300 rpm, took |
| | | | | 0:02:36 to digest undercut PR |
| 35% | 35% | 20% | 10% Acetic Acid | 0:17:06 to undercut photoresist |
| | | | | With stirring @ 500 rpm, took |
| | | | | 1:55:00 to digest undercut PR |
| 100% | — | — | — | No visual sign of attack after 364+ h |
| 40% | 40% | 20% | — | 0:05:37 to undercut photoresist |
| | | | | With stirring @ 500 rpm, took |
| | | | | 3:03:00 < t < 4:30:00 to digest |
| | | | | undercut PR |
| 40% | 40% | — | 20% Formic Acid | Layer by layer PRS visible* |
| 25% | 25% | 20% | 30% Formic Acid | 0:0:31 to undercut photoresist |
| | | | | With stirring @ 500 rpm, took |
| | | | | 0:07:55 to digest undercut PR.** |
| 20% | 20% | 20% | 40% Formic Acid | 0:0:22 to undercut photoresist |
| | | | | With stirring @ 500 rpm, took |
| | | | | 0:01:51 to digest undercut PR.** |
| 20% | 20% | 30% | 30% Formic Acid | 0:0:26 to undercut photoresist |
| | | | | With stirring @ 500 rpm, took < 0:02:00 |
| | | | | to digest undercut PR.** |
| 15% | 15% | 30% | 40% Formic Acid | 0:0:31 to undercut photoresist |
| | | | | With stirring @ 500 rpm, took < 0:02:00 |
| | | | | to digest undercut PR.** |
| 29% | 29% | 20% | 20% Formic Acid + 2% | 0:0:34 to undercut photoresist |
| | | | Phosphoric Acid | With no stirring, took < 0:02:46 to |
| | | | | digest, undercut PR.** |
| 28% | 28% | 20% | 20% Formic Acid + 4% | 0:0:26 to undercut photoresist |
| | | | Phosphoric Acid | With no stirring, took 0:01:30 to |
| | | | | digest undercut PR.** |
| 23% | 23% | 25% | 25% Formic Acid + 4% | 0:0:26 to undercut photoresist |
| | | | Phosphoric Acid | With no stirring, took 0:01:25 to |
| | | | | digest undercut PR.** |

* Experiment terminated after 2 hours. Accidental scratch of photoresist to expose bare silicon wafer underneath at 21:20 into experiment did not cause preferential attack at scratch location.
** Solution exothermed when heated beyond 60° C.

The use of heat facilitates observation of the dual mechanisms of photoresist removal at elevated temperatures. When the photoresist coated substrate is immersed in the co-solvent 1 composition, the photoresist is dissolved layer-by-layer and simultaneously undercut by the co-solvent 1 composition, which attacks the HMDS (hexa methyl di silazane) layer that binds the photoresist to the silicon wafer surface. In applications where only the wafer surface is covered with the co-solvent 1 composition, and thus the whole wafer will not be completely immersed in the co-solvent composition, the layer-by-layer dissolution mechanism is expected to predominate; and attack of the HMDS layer will most likely occur when the co-solvent can attack the photoresist from the sides.

Table 6 further illustrates that the stripping rates are accelerated by peracid formation, and that performic acid is very aggressive in photoresist stripping. It also illustrates that strip rates increased monotonically with increase in performic acid concentration and that phosphoric acid functioned as an accelerator for the performic solution. The Table 6 experiments also confirm that the oxidizer is desirable for accelerating photoresist stripping.

TABLE 7
Various Co-Solvent Compositions, Containing Alkaline Accelerators, Heated On A Hot
Plate At 80° C. and Ambient Pressure Conditions

| PC | BA | 50% H₂O₂ | Other Chemical | Stripping Time (hr:min:s) |
|---|---|---|---|---|
| 35% | 35% | 20% | 10% MEA | Layer by layer photoresist digestion |
| | | | | with 500 rpm agitation in 0:10:37. |
| | | | | Some photoresist remaining on wafer |
| | | | | surface (resist shadow visible) |
| 35% | 35% | 20% | 10% Diglycolamine | Layer by layer photoresist digestion |
| | | | | with 500 rpm agitation in 0:01:53. |
| | | | | Some photoresist remaining on wafer |
| | | | | surface (resist shadow visible) |
| 35% | 35% | 20% | 10% Triethanolamine | 0:0:39 to undercut photoresist |
| | | | | With stirring @ 500 rpm, took |
| | | | | 0:05:07 to digest undercut PR |
| 43.75% | 43.75% | — | 12.5% Triethanolamine | Undercut, undigested photoresist |
| | | | | despite 500 rpm agitation. Expt. |
| | | | | terminated after 0:30:00 |
| 43.75 | 43.75 | — | 12.5% | Did not completely undercut the PR |
| | | | Monoethanolamine | from sample surface despite 500 rpm |
| | | | | agitation |
| | | | | Undercut PR not digested |
| | | | | Expt. terminated after 0:31:00 |
| 43.75 | 43.75 | — | 12.5% Diethanolamine | Did not completely undercut the PR |
| | | | | from sample surface despite 500 rpm |
| | | | | agitation |
| | | | | Undercut PR not digested |
| | | | | Expt. terminated after 0:45:00 |
| 43.75 | 43.75 | — | 12.5% Diglycolamine | Did not completely undercut the PR |
| | | | | from sample surface despite 500 rpm |
| | | | | agitation |
| | | | | Undercut PR not digested |
| | | | | Expt. terminated after 0:32:00 |
| 43.75 | 43.75 | — | 12.5% | Did not completely undercut the PR |
| | | | Ethylenediamine | from sample surface despite 500 rpm |
| | | | | agitation |
| | | | | Undercut PR was digested |
| | | | | Expt. terminated after 1:47:00 |
| 100% | — | — | — | No visual sign of attack after 364+ h |
| — | — | — | 100% | Some photoresist remaining on wafer |
| | | | Monoethanolamine | despite complete undercut of resist in |
| | | | | 0:01:51 |
| | | | | Undercut resist digested in 0:04:25 |
| — | — | — | 100% Diethanolamine | Some photoresist remaining on wafer |
| | | | | despite complete undercut of resist in |
| | | | | 0:09:24 |
| | | | | Undercut resist not digested in |
| | | | | 1:00:00; expt. terminated |
| — | — | — | 100% Diglycolamine | Some photoresist remaining on wafer |
| | | | | with partial undercut of resist with |
| | | | | 500 rpm agitation. |
| | | | | Undercut resist not digested in |
| | | | | 0:32:00; expt. terminated |
| — | — | — | 100% Ethylene | 0:00:42 to undercut photoresist |
| | | | Diamine | With stirring @ 500 rpm, took |
| | | | | 0:01:24 to digest undercut PR |
| — | — | — | 100% Triethanolamine | Lots of photoresist remaining on |
| | | | | wafer with partial undercut of resist |
| | | | | with 500 rpm agitation. |
| | | | | Undercut resist not digested in |
| | | | | 0:30:00; expt. terminated |
| 40% | 40% | 20% | — | 0:05:37 to undercut photoresist |
| | | | | With stirring @ 500 rpm, took |
| | | | | 3:03:00 < t < 4:30:00 to digest |
| | | | | undercut PR |

Table 7 confirms the desirability of the oxidizer in the co-solvent 1 composition and the acceleration in the photoresist stripping rates by the addition of alkaline accelerators. The organoamines, such as MEA, DEA, TEA, Diglycolamine, appear to preferentially attack the HMDS layer rather than the photoresist. The only exception is the EDA solution that completely digested all the photoresist. The EDA co-solvent composition shows great promise and will be further tested to optimize the stripping rate.

### Example 12

Removal of Implanted Photoresists

The twelfth example utilized the similar co-solvent 1 compositions described in previous examples, but the composition was used on substrates having different characteristics. In this example, the blanket photoresist layer removed was a 7,000 Å thick DUV photoresist layer on top of the silicon wafer substrate. The photoresist was subjected to a high dose implant of arsenic to a dosage level of 3×10¹⁵ atoms/cm² or 8×10¹⁵ atoms/cm². Another substrate had blanket I-line photoresist layer of 12,000 Å thickness on top of the silicon wafer substrate. The photoresist was subjected to a high dose implant of arsenic to a dosage level of 3×10¹⁵ atoms/cm² or 8×10¹⁵ atoms/cm². The substrates were exposed to various co-solvent compositions shown in Table 8. Exposure to the co-solvent compositions was done using the supercritical testbed using the method described in Example 1.

TABLE 8
Co-Solvent Composition to Clean Various Challenge Wafers Under Supercritical
Conditions in a Testbed

| Challenge | | | | | |
|---|---|---|---|---|---|
| Wafer Type | PC | BA | 50% H₂O₂ | Other Chemical | Result |
| Blanket DUV | 29% | 29% | 20% | 20% Formic Acid + 2% | Complete stripping in t |
| photoresist; | | | | Phosphoric Acid | where t ≦ 30 s |
| 7,000 Å thick | | | | | |
| As implanted | 29% | 29% | 20% | 20% Formic Acid + 2% | Complete stripping in t |
| DUV | | | | Phosphoric Acid | where t = 2 min., 30 s |
| photoresist; | | | | | |
| 3 × 10¹⁵ atoms/cm² | | | | | |
| As implanted | 29% | 29% | 20% | 20% Formic Acid + 2% | Complete stripping in t |
| DUV | | | | Phosphoric Acid | where t = 4 min., 30 s |
| photoresist; | | | | | |
| 8 × 10¹⁵ atoms/cm² | | | | | |
| Blanket I-line | 29% | 29% | 20% | 20% Formic Acid + 2% | Complete stripping in t |
| photoresist; | | | | Phosphoric Acid | where t ≦ 30 s |
| 12,000 Å thick | | | | | |
| As implanted I- | 29% | 29% | 20% | 20% Formic Acid + 2% | Complete stripping in t |
| line photoresist; | | | | Phosphoric Acid | where t = 2 min., 30 s |
| 3 × 10¹⁵ atoms/cm² | | | | | |
| As implanted I- | 29% | 29% | 20% | 20% Formic Acid + 2% | Complete stripping in t |
| line photoresist; | | | | Phosphoric Acid | where t = 4 min., 30 s |
| 8 × 10¹⁵ atoms/cm² | | | | | |

Table 8 clearly shows that the compositions described herein can satisfactorily remove ion implanted photoresists. Using current industry practice, these implant levels cannot be removed by liquid chemicals along, but instead must be removed by a combination of plasma etching followed by wet cleaning to remove the etch residue.

### Example 13

The thirteenth example utilized the same co-solvent 1 composition as used in Example 12, but the composition was used in a supercritical tool that was able to process a complete 200 mm wafer according to the procedure described earlier. Results are shown in Table 9.

TABLE 9
Co-Solvent Composition to Clean Various Challenge Wafers at
Supercritical Conditions in a 200 mm Wafer Tool

| Challenge | | | 50% | Other | |
|---|---|---|---|---|---|
| Wafer Type | PC | BA | H₂O₂ | Chemical | Result |
| Blanket DUV | 29% | 29% | 20% | 20% Formic | Complete |
| photoresist; | | | | Acid + 2% | stripping in t |
| 7,000 Å thick | | | | Phosphoric Acid | where |
| | | | | | t ≦ 2 min. |
| Blanket I-line | 29% | 29% | 20% | 20% Formic | Complete |
| photoresist; | | | | Acid + 2% | stripping in t |
| 12,000 Å thick | | | | Phosphoric Acid | where |
| | | | | | t ≦ 2 min. |

Table 9 shows that scCO₂ cleaning of 200 mm wafers is possible at high strip rates. Further refinements to the scCO₂ cleaning process and to the co-solvent 1 composition are expected to further increase the stripping rates.

### Example 14

Accelerating Formic Acid Based Formulations

The fourteenth example utilized salts as an accelerator for the performic acid based co-solvent 1 mixture. Various co-solvent 1 compositions, shown in Table 10, were prepared and tested according to the procedure detailed in Example 9 using As implanted photoresist (3×10¹⁵ atoms/cm²) wafer of the type also used in Example 12. Results are shown in Table 10.

TABLE 10
Performic Acid Co-Solvent Composition Accelerated With Salts
to Clean Arsenic Implanted Challenge Wafer Under Supercritical
Conditions in a Testbed

| | | 50% | | | |
|---|---|---|---|---|---|
| PC | BA | H₂O₂ | Chemical 1 | Chemical 2 | Result |
| 20% | 20% | 20% | 20% of | 20% of | Complete |
| | | | Formic Acid | Hydroxyl | stripping in |
| | | | | Propyl | t where |
| | | | | Carbamate | 2:30 < t ≦ 3:00 |
| 20% | 20% | 20% | 20% of | 20% of 1:1 | Complete |
| | | | Formic Acid | mixture of | stripping in |
| | | | | ammonium | t where |
| | | | | acetate & | 1 < t ≦ 1:30 |
| | | | | DI water | |
| 20% | 20% | 20% | 20% of | 20% of | Complete |
| | | | Formic Acid | Propylene | stripping in |
| | | | | Glycol | t where |
| | | | | | 1:30 < t ≦ 2:00 |
| 20% | 20% | 20% | 20% of | 20% of | Incomplete |
| | | | Formic Acid | DI water | stripping in |
| | | | | | t where |
| | | | | | t > 3:00 |
| 25% | 25% | 25% | 25% of | — | Complete |
| | | | Formic Acid | | stripping in |
| | | | | | t where |
| | | | | | t = 2:30 |

Table 10 shows that salts and glycols can be used to accelerate the performic solutions making it even more aggressive in PRS.

### Example 15

Post-Etch Residue Removal

The fifteenth example used the hydroxyl propyl carbamate (HPC) solution (25% PC, 25% BA, 25% HPC and 25% of 50% hydrogen peroxide) to clean up photoresists and etch residue from two different challenge wafers according to the procedure described in Example 9. The first wafer was a gate stack wafer that had ˜2000 Å thick etched photoresist layer remaining on top of a nitride layer which covered a metal silicide layer. The silicide layer covered a polysilicon layer which covered a gate oxide layer which overlay the silicon wafer surface. The wafer had gone through a fluorine plasma etch process to define a via and had considerable Teflon like polymer covering the via sidewall. A comparison of the as-received wafer SEM micrograph with the post-process micrograph revealed complete removal of photoresist and etch residue. Both top down and cross-sectional images of the post-process wafer show complete removal of photoresist and sidewall polymer without any attack of the stack.

The second challenge post-etch wafer was a shallow contact that had ˜4000 Å thick etched photoresist layer remaining on top of a BPSG (borophosphosilicate glass) layer which enveloped a contact. The contact had a metal silicide layer on top of a polysilicon layer with a nitride spacer for the contact. The wafer had gone through a fluorine plasma etch process to define a via and had considerable Teflon-like polymer covering the via sidewall. A comparison of the as-received wafer SEM micrograph with the post-process micrograph revealed complete removal of photoresist and etch residue. Both top down and cross-sectional images of the post-process wafer show complete removal of photoresist and sidewall polymer without any attack of the BPSG layer.

Complete cleaning of the two different post-etch wafers in a single supercritical cleaning processing step is very significant as the current ambient pressure processing of these wafers needs two or more processing steps to remove the photoresist and the etch residue, as explained in the background section of this application.

It is significant to note that, as with the cleaning in all of the examples of this application, the cleaning in this example was carried out at a single operating pressure without any pressure cycling. Several known processes use pressure cycling to remove photoresist and etch residue from wafer surfaces under scCO₂ conditions. In these processes, pressure cycling is needed because the processes use solutions that undercut the photoresist and lift it off the substrate. The undercut photoresist needs to be moved off the wafer surface and dissolved into the co-solvent mixture and/or captured in a filter. These known processes achieve this by recirculating the scCO₂ and co-solvent mixture at a high rate in a process loop, and partially and fully exhausting the high pressure chamber. In contrast, the embodiments described herein utilize co-solvent mixtures that dissolve the photoresist and etch residue into the co-solvent 1 mixture, thus avoiding the need for wasteful pressure cycling.

The successful simultaneous removal of photoresist and etch residue using hydrogen peroxide in an organic solvent based stripper as described is highly advantageous over existing methods. Typically toxic amines are used at elevated temperatures and pose considerable risks to the equipment, operator and have considerable disposal costs. The compositions using environmentally friendly hydrogen peroxide, as detailed in this application, offer considerable safety and cost advantages while maintaining or exceeding the current photoresist stripping rate and the ease of use.

All current post-etch and post-ash formulations used in the industry contain varying amounts of toxic fluoride ions to attack and dissolve the Teflon like etch residue generated by fluorine plasmas. It is notable that Example 15 demonstrated complete removal of a fluorine plasma generated etch residue without using any fluorine in the cleaning co-solvent composition. It is believed that the success of this formulation relies on the presence of a large amount of an aggressive and yet environmentally friendly oxidizer such as hydrogen peroxide.

### Example 16

Trioxane Accelerated Formulation

The sixteenth example utilized trioxane as an accelerator for the PC/BA/H₂O₂ based co-solvent 1 mixture. A 10% Trioxane solution, shown in Table 11, was prepared and tested according to the procedure detailed in Example 9 using the challenge substrate (10,000′Å thick, completely cross-linked I-line photoresist).

TABLE 11
Trioxane Accelerated Co-Solvent Composition to
Clean Cross-Linked I-line Photoresist Challenge
Wafer Under Supercritical Conditions in a Testbed

| PC | BA | 50% H2₂O₂ | Other Chemical | Result |
|---|---|---|---|---|
| 35% | 35% | 20% | 10% of 1,3,5 | Complete stripping in t |
| | | | Trioxane | where t ≦ 30 s |

The Trioxane composition, specified in Table 11, was tested on wafers having arsenic implanted photoresist (3×10¹⁵ atoms/cm²) as also used in Example 12. Results are shown in Table 12.

TABLE 12
Trioxane Accelerated Co-Solvent Composition to Clean Arsenic
Implanted Photoresist Challenge Wafer Under
Supercritical Conditions in a Testbed

| Challenge | | | 50% | Other | |
|---|---|---|---|---|---|
| Wafer Type | PC | BA | H₂O₂ | Chemical | Result |
| As implanted | 35% | 35% | 20% | 10% of 1,3,5 | Complete |
| I-line | | | | Trioxane | stripping in |
| photoresist; | | | | | t where |
| 3 × 10¹⁵ atoms/cm² | | | | | t ≦ 1 min. |

Table 12 shows that the Trioxane solution has given the fastest PRS rate for the implanted wafers. Results of ambient pressure testing on a hot plate and under supercritical conditions show that the Trioxane solution has extremely high photoresist stripping rates. For example, photoresist stripping of a challenge substrate (10,000′Å thick, completely cross-linked I-line photoresist) was performed using the Trioxane solution specified above heated on a hot plate at 80° C. and ambient pressure, as was done in Example 11. It took 1 min., 30 s to undercut the photoresist and 2 min, 40 s to completely dissolve the undercut photoresist. In another experiment, exposure of the challenge I-line substrate to an unstirred trioxane solution (composition given in Table 12) at ambient pressure and temperature resulted in stripping in a time of between 32 hours and 52 hours, 40 min.

Trioxane is an ether solvent and is the cyclic trimeric polymer of formaldehyde and is also known as 1,3,5 trioxane or trioxymethylene. Heat, strong oxidizers or acids decompose trioxane to formaldehyde with the rate of decomposition being easily controlled. In this example, the application of heat decomposes a molecule of trioxane to 3 molecules of formaldehyde with the resulting volume expansion mechanically tearing up the photoresist. The formaldehyde is oxidized (by the hydrogen peroxide in the mix) to formic acid and subsequently to performic acid. The performic acid, along with the other chemicals in the co-solvent 1 mixture, then attacks and dissolves the photoresist while the propylene carbonate dissolves the photoresist and/or resist residue and keeps the co-solvent 1 solution single phase.

What is noteworthy about the Trioxane accelerated co-solvent mixture is that Trioxane can be used to create in-situ performic acid in the scCO₂ process chamber. At ambient temperature and pressure conditions, the trioxane formulation is stable in composition, and is far more stable at room temperature than performic solutions, made using formic acid.

All patents, patent applications, and publications disclosed herein are incorporated by reference in their entirety, as if individually incorporated. The foregoing detailed description, examples, and drawing are only illustrative of preferred embodiments which achieve the objects, features and advantages of the present invention and have been given for clarity of understanding only. No unnecessary limitations are to be understood therefrom. The invention is not limited to the exact details shown and described, for variations obvious to one skilled in the art will be included within the invention defined by the claims.

What is claimed is:

1. A method of removing photoresist and/or resist residue from a substrate, comprising the steps of:
(a) providing a substrate having photoresist material formed thereon;
(b) exposing the substrate to a co-solvent mixture comprising a carbonate, an oxidizer and an accelerator.

2. The method of claim 1, wherein the exposing step includes exposing the substrate to a supercritical fluid in combination with the co-solvent mixture.

3. The method of claim 1 in which the carbonate is selected from the group consisting of 1,2-Butylene Carbonate, Ethylene Carbonate, Propylene Carbonate and mixtures thereof.

4. The method of claim 3, wherein the carbonate includes 1,2-Butylene Carbonate.

5. The method of claim 3, wherein the carbonate includes Propylene Carbonate.

6. The method of claim 3, wherein the carbonate includes Ethylene Carbonate.

7. The method of claim 1, wherein the co-solvent mixture includes Dimethyl Sulfoxide.

8. The method of claim 1, wherein the co-solvent mixture includes Benzyl Alcohol.

9. The method of claim 1, wherein the co-solvent mixture includes 1,2-Butylene Carbonate, and Dimethyl Sulfoxide.

10. The method of claim 1, wherein the co-solvent mixture includes 1,2-Butylene Carbonate and Benzyl Alcohol.

11. The method of claim 1, wherein the co-solvent mixture includes Propylene Carbonate and Benzyl Alcohol.

12. The method of claim 1, wherein the co-solvent mixture includes Ethylene Carbonate and Benzyl Alcohol.

13. The method of claim 1, wherein the co-solvent mixture includes an aqueous fluoride.

14. The method of claim 14, wherein the aqueous fluoride is selected from the group consisting of ammonium fluoride, ammonium bifluoride and hydrofluoric acid.

15. The method of claim 1, wherein the oxidizer is selected from the group consisting of hydrogen peroxide, benzoyl peroxide, urea peroxide and mixtures thereof.

16. The method of claim 15, wherein the oxidizer is 10-80% hydrogen peroxide.

17. The method of claim 1, wherein the accelerator is a C₁-C₂₂ carboxylic acid.

18. The method of claim 17, wherein the accelerator is selected from the group consisting of formic acid, acetic acid, oxalic acid, citric acid, maleic acid, malic acid, lactic acid, glycolic acid, and L-tartaric acid.

19. The method of claim 18, wherein the accelerator is formic acid.

20. The method of claim 1, wherein the accelerator is an organoamine.

21. The method of claim 20, wherein the accelerator is selected from the group consisting of diethanolamine, diglycolamine, ethylene diamine, isopropyl amine, monoethanol amine, morpholine, and triethanolamine.

22. The method of claim 1, wherein the accelerator is a salt.

23. The method of claim 22, wherein the accelerator is selected from the group consisting of ammonium carbamate, ammonium carbonate, ammonium formate, and hydroxy propyl carbamate.

24. The method of claim 1, wherein the accelerator is a solvent.

25. The method of claim 24, wherein the solvent is an ether.

26. The method of claim 25, wherein the ether is 1,3,5 Trixoane.

27. The method of claim 24, wherein the solvent is a glycol.

28. The method of claim 27, wherein the glycol is propylene glycol.

29. The method of claim 24, wherein the solvent is a lower alkyl alcohol.

30. The method of claim 24, wherein the solvent is selected from the group consisting of methanol and ethanol and mixtures thereof.

31. The method of claim 1, wherein the exposing step causes stripping of photoresist material from the substrate.

32. The method of claim 1, wherein the exposing step cleans resist residue from the substrate.

33. The method of claim 31, wherein the co-solvent mixture is a first co-solvent mixture and wherein the method further includes the step of, after step (b), exposing the substrate to a second mixture comprising a supercritical fluid in combination with isopropyl alcohol.

34. The method of claim 33, wherein the second co-solvent mixture includes supercritical fluid in combination with isopropyl alcohol and water.

35. The method of claim 33, wherein the step of exposing the substrate to the second co-solvent mixture removes the first co-solvent mixture from the substrate and dries the substrate.

36. The method of claim 1, wherein the substrate includes I-line photoresist and wherein the method is for removing the I-line photoresist.

37. The method of claim 1, wherein the substrate is a substrate previously exposed to ion implantation.

38. The method of claim 1, wherein the substrate includes aluminum lines formed thereon.

39. The method of claim 1, wherein the substrate includes at least one integrated circuit device including low-dielectric constant materials.

40. The method of claim 1, wherein the substrate includes at least one integrated circuit device having high dielectric constant gate materials.

41. The method of claim 1, wherein the substrate includes back anti-reflective coating and wherein the method removes the back anti-reflective coating from the substrate.

42. The method of claim 1, wherein the substrate includes deep UV photoresist and wherein the method removes the DUV photoresist from the substrate.

43. The method of claim 1, wherein the substrate includes post-ash residues, and wherein the method includes removing the post-ash residues from the substrate.

44. The method of claim 1, wherein the substrate includes photoresist and post-etch residues, and wherein exposure of the substrate to the co-solvent mixture removes both the photoresist and the post-etch residues from the substrate.

45. The method of claim 1, wherein the supercritical fluid is supercritical carbon dioxide.

46. A composition for removing photoresist and/or resist residues from a substrate, the composition comprising:
a co-solvent mixture comprising a carbonate, an oxidizer and an accelerator.

47. The composition of claim 46, further including a supercritical fluid in combination with the co-solvent mixture.

48. The composition of claim 46 in which the carbonate is selected from the group consisting of 1,2-Butylene Carbonate, Ethylene Carbonate, Propylene Carbonate and mixtures thereof.

49. The composition of claim 48, wherein the carbonate includes 1,2-Butylene Carbonate.

50. The composition of claim 48, wherein the carbonate includes Propylene Carbonate.

51. The composition of claim 48, wherein the carbonate includes Ethylene Carbonate.

52. The composition of claim 46, wherein the co-solvent mixture includes Dimethyl Sulfoxide.

53. The composition of claim 46, wherein the co-solvent mixture includes Benzyl Alcohol.

54. The composition of claim 46, wherein the co-solvent mixture includes 1,2-Butylene Carbonate, and Dimethyl Sulfoxide.

55. The composition of claim 46, wherein the co-solvent mixture includes 1,2-Butylene Carbonate and Benzyl Alcohol.

56. The composition of claim 46, wherein the co-solvent mixture includes Propylene Carbonate and Benzyl Alcohol.

57. The composition of claim 46, wherein the co-solvent mixture includes Ethylene Carbonate and Benzyl Alcohol.

58. The composition of claim 46, wherein the co-solvent mixture include an aqueous fluoride.

59. The composition of claim 58, wherein the aqueous fluoride is selected from the group consisting of ammonium fluoride, ammonium bifluoride and hydrofluoric acid.

60. The composition of claim 46. wherein the oxidizer is selected from the group consisting of hydrogen peroxide, benzoyl peroxide, urea peroxide and mixtures thereof.

61. The composition of claim 60, wherein the oxidizer is 10-80% hydrogen peroxide.

62. The composition of claim 46, wherein the accelerator is a C₁-C₂₂ carboxylic acid.

63. The composition of claim 46, wherein the accelerator is selected from the group consisting of formic acid and acetic acid, oxalic acid, citric acid, maleic acid, malic acid, lactic acid, glycolic acid, and L-tartaric acid.

64. The composition of claim 63, wherein the accelerator is formic acid.

65. The composition of claim 46, wherein the accelerator is an organoamine.

66. The composition of claim 65, wherein the accelerator is selected from the group consisting of diethanolamine, diglycolamine, ethylene diamine, isopropyl amine, monoethanol amine, morpholine, and triethanolamine.

67. The composition of claim 46, wherein the accelerator is a salt.

68. The composition of claim 67, wherein the accelerator is selected from the group consisting of ammonium carbamate, ammonium carbonate, ammonium formate, and hydroxy propyl carbamate.

69. The composition of claim 30, wherein the supercritical fluid is supercritical carbon dioxide.

70. A composition for removing photoresist and/or resist residue from a substrate, the composition comprising including propylene carbonate, benzyl alcohol, hydrogen peroxide, and formic acid.

71. The composition of claim 70, further including supercritical carbon dioxide.

72. A composition for removing photoresist and/or resist residual from a substrate, the composition comprising including propylene carbonate, benzyl alcohol and ethylene diamine.

73. The composition of claim 72, further including supercritical carbon dioxide.

74. A composition for removing photoresist and/or resist residual from a substrate, the composition comprising propylene carbonate, benzyl alcohol, formic acid, hydrogen peroxide, and an accelerator selected from the group consisting of hydroxyl propyl carbamate, propylene glycol and ammonium acetate in combination with deionized water.

75. A composition for removing photoresist and/or resist residue from a substrate, the composition comprising propylene carbonate, benzyl alcohol, hydroxyl propyl carbamate and hydrogen peroxide.

76. A composition for removing photoresist and/or resist residue from a substrate, the composition comprising propylene carbonate, benzyl alcohol, Trioxane and hydrogen peroxide.
